(19) United States
(12) Patent Application Publication
(10) Pub. No.: US 2024/0346479 A1
(43) Pub. Date: Oct. 17, 2024

(54) SYSTEMS AND METHODS FOR PROVIDING A USER INTERFACE FOR ONLINE CHECKOUT USING A SHARED WALLET ACROSS ISSUERS

(71) Applicant: EARLY WARNING SERVICES, LLC, SCOTTSDALE, AZ (US)

(72) Inventors: Greg Slowiak, Chicago, IL (US); Michael Dempsey, Chicago, IL (US); James Anderson, Kent, CT (US); Matthew Miller, Honolulu, HI (US); Laura Menken, Austin, TX (US)

(73) Assignee: EARLY WARNING SERVICES, LLC, SCOTTSDALE, AZ (US)

(21) Appl. No.: 18/398,753

(22) Filed: Dec. 28, 2023

Related U.S. Application Data
(60) Provisional application No. 63/458,603, filed on Apr. 11, 2023.

(51) Int. Cl. G06Q 20/22; G06Q 20/36; G06Q 20/38

(52) U.S. Cl. CPC G06Q 20/227; G06Q 20/3674; G06Q 20/385

(57) ABSTRACT

A method including obtaining a unique identifier for a user. The method also can include causing an authentication code to be sent to a device of the user. The method additionally can include receiving, through a first user interface displayed to the user, the authentication code. The method further can include displaying, to the user through the first user interface, a list of cards in a shared wallet for the user. The cards can be issued from multiple different issuers. The shared wallet can be accessible to multiple different merchants. The method additionally can include receiving, through the first user interface displayed to the user, a selection from the user of a selected card from the list of the cards for processing a transaction. The method further can include providing card information for the selected card to a merchant for processing the transaction. Other embodiments of related systems and methods are described.

### CROSS-REFERENCE TO RELATED APPLICATION

This application claims the benefit of U.S. Provisional Application No. 63/458,603, filed Apr. 11, 2023. U.S. Provisional Application No. 63/458,603 is incorporated herein by reference in its entirety.

### TECHNICAL FIELD

This disclosure relates generally to providing a user interface for online checkout using a shared wallet across issuers.

### BACKGROUND

Conventional online checkout typically involves a user providing card details to the merchant for the transaction. The merchant often provides the option to store the card information so that the user is not asked for the card information the next time the user does an online checkout at the same merchant. User often have multiple different cards, which are often issued by multiple different card issuers. Additionally, users often use websites of many different merchants, each with their own checkout system.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for providing a user interface for online checkout using a shared wallet across issuers, according to an embodiment;

FIG. 4 illustrates an exemplary display screen of a first graphical user interface for a checkout page;

FIG. 5 illustrates an exemplary display screen of a second graphical user interface for introducing the user to a shared wallet checkout process;

FIG. 6 illustrates an exemplary display screen of the second graphical user interface for receiving an authentication code;

FIG. 7 illustrates an exemplary display screen of the second graphical user interface for verifying the authentication code received in FIG. 6;

FIG. 8 illustrates an exemplary display screen of the second graphical user interface for selecting a card;

FIG. 9 illustrates an exemplary display screen of the second graphical user interface for a card details page for the card selected in FIG. 8;

FIG. 10 illustrates an exemplary display screen of the second graphical user interface for selecting a shipping address;

FIG. 11 illustrates an exemplary display screen of the second graphical user interface for reviewing checkout selections;

FIG. 12 illustrates an exemplary display screen of the first graphical user interface for confirming checkout details;

FIG. 13 illustrates an exemplary display screen of the first graphical user interface for an order confirmation page;

FIG. 14 illustrates an exemplary display screen of the second graphical user interface for receiving an authentication code;

FIG. 15 illustrates an exemplary display screen of the second graphical user interface for verifying the authentication code received in FIG. 14;

FIG. 16 illustrates an exemplary display screen of the second graphical user interface for reviewing checkout selections;

FIG. 17 illustrates an exemplary display screen of the second graphical user interface for selecting a card;

FIG. 18 illustrates an exemplary display screen of the second graphical user interface for selecting a shipping address;

FIG. 19 illustrates an exemplary display screen of the first graphical user interface for an order confirmation page;

FIG. 20 illustrates an exemplary display screen of the second graphical user interface for selecting a shipping address;

FIG. 21 illustrates an exemplary display screen of the second graphical user interface for entering a new shipping address;

FIG. 22 illustrates an exemplary display screen of the second graphical user interface for continuing to enter the new shipping address entered in FIG. 21;

FIG. 23 illustrates an exemplary display screen of the second graphical user interface for continuing to enter the new shipping address entered in FIGS. 21-22;

FIG. 24 illustrates an exemplary display screen of the second graphical user interface for reviewing checkout selections;

FIG. 25 illustrates an exemplary display screen of the first graphical user interface for an order confirmation page;

FIG. 26 illustrates an exemplary display screen of the second graphical user interface for introducing the user to opting out of the shared wallet checkout process;

FIG. 27 illustrates an exemplary display screen of the second graphical user interface for receiving an authentication code;

FIG. 28 illustrates an exemplary display screen of the second graphical user interface for verifying the authentication code received in FIG. 27;

FIG. 29 illustrates an exemplary display screen of the second graphical user interface for confirming that the user opted out of the shared wallet checkout process;

FIG. 30 illustrates an exemplary display screen of the second graphical user interface for listing selectable customer feedback options;

FIG. 31 illustrates an exemplary display screen of the second graphical user interface for finishing the opt out process and returning to the merchant checkout process after opting out;

FIG. 32 illustrates an exemplary display screen of the second graphical user interface for selecting a phone number associated with the shared wallet when the phone number originally entered is not recognized;

FIG. 33 illustrates an exemplary display screen of the second graphical user interface for receiving an authentication code;

FIG. 34 illustrates an exemplary display screen of the second graphical user interface for informing the user that the shared wallet checkout process is not available;

FIG. 35 illustrates an exemplary display screen of the second graphical user interface for selecting a phone number associated with the shared wallet when the email address entered in FIG. 4 is shared across multiple different wallets;

FIG. 36 illustrates flow charts for two methods of handling an authentication failure, according to embodiments;

FIG. 37 illustrates an exemplary display screen of the second graphical user interface for informing the user that something went wrong in the shared wallet checkout process;

FIG. 38 illustrates an exemplary display screen of the second graphical user interface for receiving an authentication code to allow for retries;

FIG. 39 illustrates an exemplary display screen of the second graphical user interface for informing the user that the user cannot use the shared wallet checkout process at this time;

FIG. 40 illustrates an exemplary display screen of a first graphical user interface for a checkout page;

FIG. 41 illustrates an exemplary display screen of a first graphical user interface for displaying checkout options;

FIG. 42 illustrates an exemplary display screen of a second graphical user interface for entering an email address;

FIG. 43 illustrates an exemplary display screen of a second graphical user interface for displaying an information tool-tip about the shared wallet checkout process;

FIG. 44 illustrates an exemplary display screen of a wallet management graphical user interface for displaying information about the shared wallet;

FIG. 45 illustrates an exemplary display screen of a wallet management graphical user interface for receiving an authentication code;

FIG. 46 illustrates an exemplary display screen of a wallet management graphical user interface for displaying a wallet management portal;

FIG. 47 illustrates an exemplary display screen of a wallet management graphical user interface for deleting the shared wallet;

FIG. 48 illustrates an exemplary display screen of a wallet management graphical user interface for confirming deletion of the shared wallet;

FIG. 49 illustrates an exemplary display screen of a wallet management graphical user interface for selecting a card and adding a new card;

FIG. 50 illustrates an exemplary display screen of a wallet management graphical user interface for linking to the issuer; and

FIG. 51 illustrates a flow chart for a method of providing a user interface for online checkout using a shared wallet across issuers, according to an embodiment.

For simplicity and clarity of illustration, the drawing figures herein illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, two minutes, or five minutes.

### DESCRIPTION OF EXAMPLES OF EMBODIMENTS

Various embodiments include a computer-implemented method. The method can include obtaining a unique identifier for a user. The method also can include causing an authentication code to be sent to a device of the user. The method additionally can include receiving, through a first user interface displayed to the user, the authentication code. The method further can include displaying, to the user through the first user interface, a list of cards in a shared wallet for the user. The cards can be issued from multiple different issuers. The shared wallet can be accessible to multiple different merchants. The method additionally can include receiving, through the first user interface displayed to the user, a selection from the user of a selected card from the list of the cards for processing a transaction. The method further can include providing card information for the selected card to a merchant for processing the transaction.

A number of embodiments include a system including one or more processors and one or more non-transitory computer-readable media storing computing instructions that, when executed on the one or more processors, cause the one or more processors to perform operations. The operations can include obtaining a unique identifier for a user. The operations also can include causing an authentication code to be sent to a device of the user. The operations additionally can include receiving, through a first user interface displayed to the user, the authentication code. The operations further can include displaying, to the user through the first user interface, a list of cards in a shared wallet for the user. The cards can be issued from multiple different issuers. The shared wallet can be accessible to multiple different merchants. The operations additionally can include receiving, through the first user interface displayed to the user, a selection from the user of a selected card from the list of the cards for processing a transaction. The operations further can include providing card information for the selected card to a merchant for processing the transaction.

Further embodiments include one or more non-transitory computer-readable media storing computing instructions that, when executed on the one or more processors, cause the one or more processors to perform operations. The operations can include obtaining a unique identifier for a user. The operations also can include causing an authentication code to be sent to a device of the user. The operations additionally can include receiving, through a first user interface displayed to the user, the authentication code. The operations further can include displaying, to the user through the first user interface, a list of cards in a shared wallet for the user. The cards can be issued from multiple different issuers. The shared wallet can be accessible to multiple different merchants. The operations additionally can include receiving, through the first user interface displayed to the user, a selection from the user of a selected card from the list of the cards for processing a transaction. The operations further can include providing card information for the selected card to a merchant for processing the transaction.

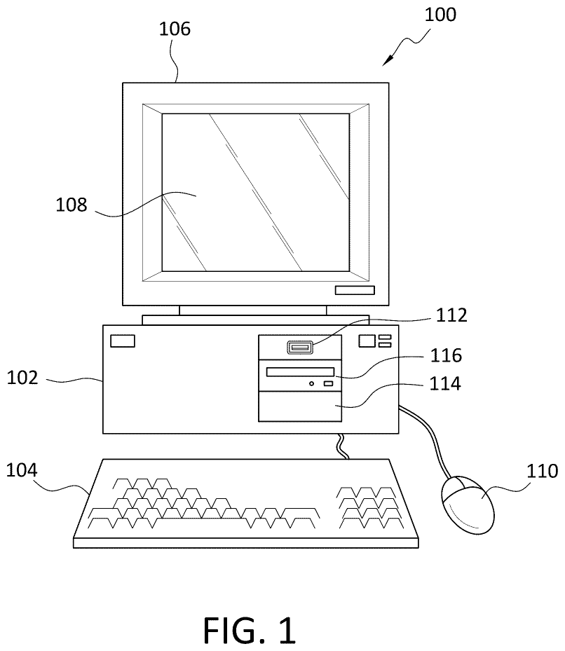

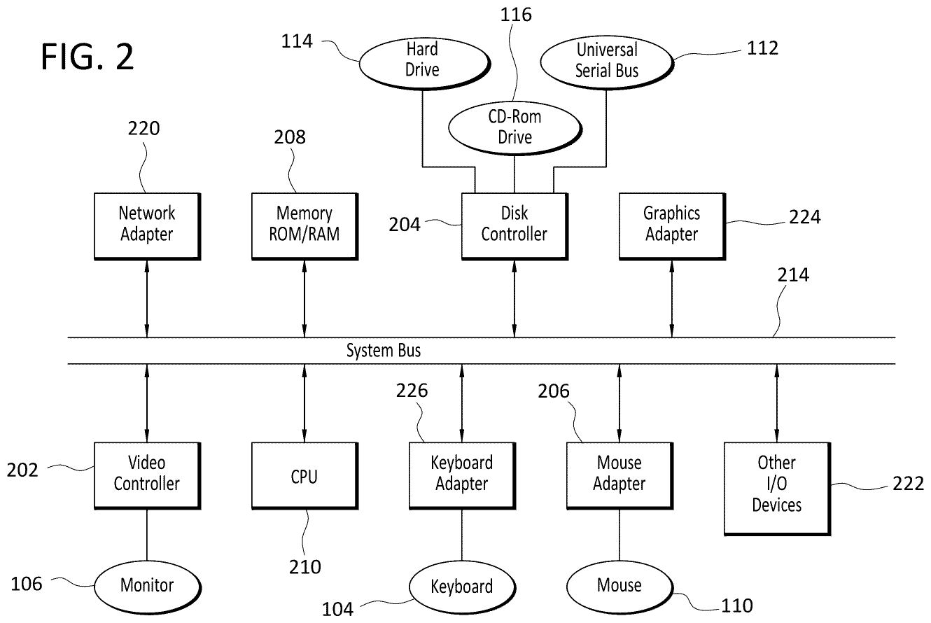

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIGS. 1-2). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) or Field Programmable Gate Arrays (FPGAs) can be programmed to carry out one or more of the systems and procedures described herein. For example, one or more of the programs and/or executable program components described herein can be implemented in one or more ASICs or FPGAs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

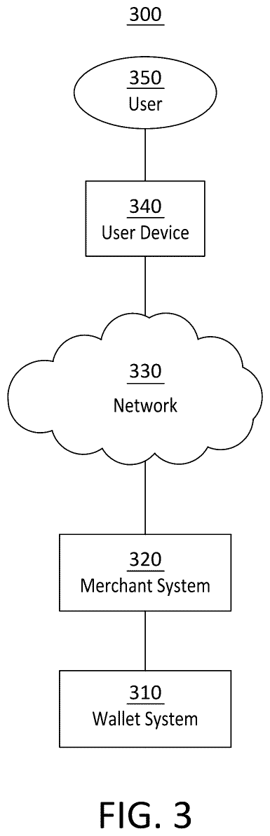

Turning ahead in the drawings, FIG. 3 illustrates a block diagram of a system 300 that can be employed for providing a user interface for online checkout using a shared wallet across issuers, according to an embodiment. System 300 is merely exemplary, and embodiments of the system are not limited to the embodiments presented herein. The system can be employed in many different embodiments or examples not specifically depicted or described herein. In some embodiments, certain elements of system 300 can perform various procedures, processes, and/or activities. In other embodiments, the procedures, processes, and/or activities can be performed by other suitable elements of system 300. Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Wallet system 310 and/or merchant system 320 can each be a computer system, such as computer system 100 (FIG. 1), as described above, and can each be a single computer, a single server, or a cluster or collection of computers or servers, or a cloud of computers or servers. In another embodiment, a single computer system can host wallet system 310 and/or merchant system 320. Additional details regarding wallet system 310 and/or merchant system 320 are described herein.

In some embodiments, merchant system 320 can be in data communication through a network 330 with one or more user devices, such as a user device 340. User device 340 can be part of system 300 or external to system 300. Network 330 can be the Internet or another suitable network. In some embodiments, user device 340 can be used by users, such as a user 350. In many embodiments, merchant system 320 can host one or more websites and/or application servers. For example, merchant system 320 can host a website, or provide a server that interfaces with an application (e.g., a mobile application), on user device 340, which can allow users (e.g., 350) to search for items (e.g., products, grocery items), to add items to an electronic cart, and/or to purchase items through an online merchant checkout process, in addition to other suitable activities. In several embodiments, wallet system 310 can provide wallet services to merchant system 320, to allow merchant system 320 to provide to users (e.g., 350) an online “bank checkout” process that uses the wallet services. In many embodiments, wallet system 310 can interact with other systems, such as issuers, token service providers, etc., to provide the wallet services. In many embodiments, the wallet services can provide a shared wallet for multiple payment cards (e.g., credit cards, debit cards, etc.) that were issued by multiple different issuers. In several embodiments, wallet system 310 can provide the wallet services to multiple different merchants (individually or simultaneously), each using a merchant system (e.g., 320).

In some embodiments, wallet system 310 and merchant system 320 can communicate with each other through network 330 and/or an internal network that is not open to the public. In some embodiments, wallet system 310 (and/or the software used by such systems) can refer to a back end of system 300 operated by an operator and/or administrator of system 300, and merchant system 320 (and/or the software used by such systems) can refer to a front end of system 300, as it can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Lumia® or similar product by the Nokia Corporation of Keilaniemi, Espoo, Finland, and/or (iii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Android™ operating system developed by the Open Handset Alliance, or (iii) the Windows Mobile™ operating system by Microsoft Corp. of Redmond, Washington, United States of America.

In many embodiments, wallet system 310 and/or merchant system 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to wallet system 310 and/or merchant system 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of wallet system 310 and/or merchant system 320. In a similar manner, the processors and/or the non-transitory computer-readable media can be local and/or remote to each other.

Meanwhile, in many embodiments, wallet system 310 and/or merchant system 320 also can be configured to communicate with one or more databases (not shown). The one or more databases can include a wallet directory, for example, among other information. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, wallet system 310, merchant system 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, merchants can enroll with the wallet service provided by wallet system 310, so that wallet system 310 can provide an SDK (Software Development Kit) or other suitable process that allow merchant system 320 to interface with wallet system 310 and provide the bank checkout process to users (e.g., 340). For example, merchant system 320 can run an SDK to operate the bank checkout process that uses the shared wallet provided by wallet system 310. Wallet system 310 can create and/or store a wallet for each user in a wallet directory. The wallet directory can include a single shared wallet for a user that can be used for multiple different payment cards associated with the user, including multiple cards from different issuers. The wallet for a user can include information about the payment cards, such as tokenization information for the payment cards, along with other information identifying the user, such as an email address of the user, a phone number of the user, a social security number of the user (or hash thereof). The wallet directory can be pre-populated before the merchant offers the user the opportunity to use the bank checkout process that uses the wallet associated with the user.

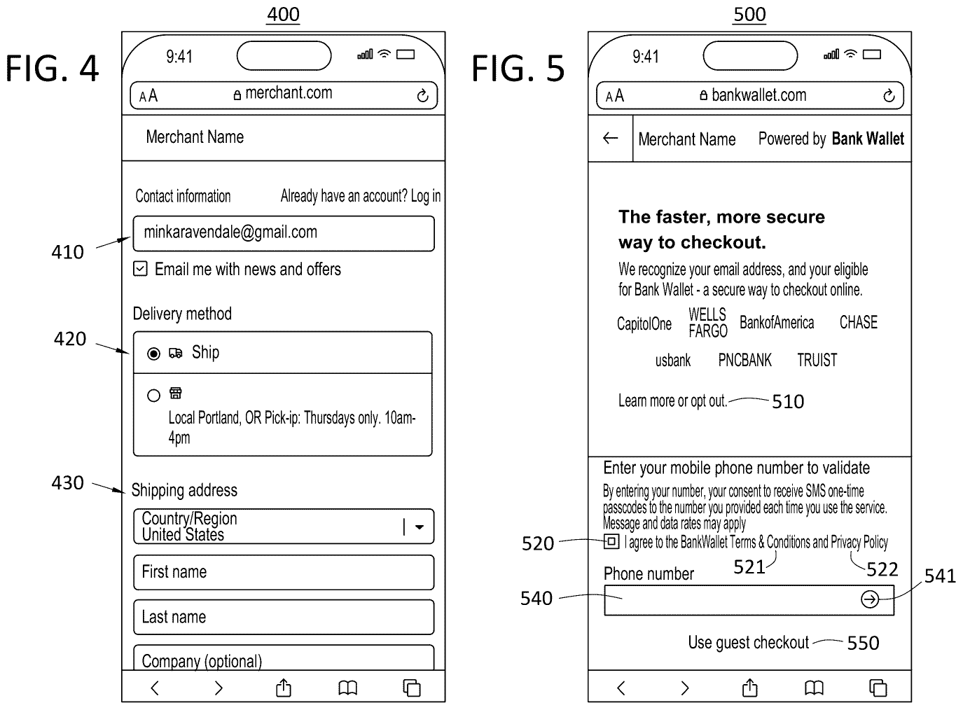

Turning ahead in the drawings, FIGS. 4-35 and 37-50 illustrate exemplary display screens of a graphical user interface (GUI) of an application (e.g., mobile application) or website (e.g., mobile website or non-mobile website) displayed on user device 340 (FIG. 3) used by a user (e.g., 350 (FIG. 3)). The display screens are merely exemplary, and embodiments of these display screens are not limited to the display screen shown and described. The display screens can be implemented in many different embodiments or examples not specifically depicted or described herein. These display screens are provided to user device 340 (FIG. 3) by merchant system 320 (FIG. 3). In many embodiments, the display screens can allow a user (e.g., 350 (FIG. 3)) of user device 340 (FIG. 3) to proceed through the bank checkout process offered through merchant system 320 (FIG. 3) using the wallet provided by wallet system 310 (FIG. 3).

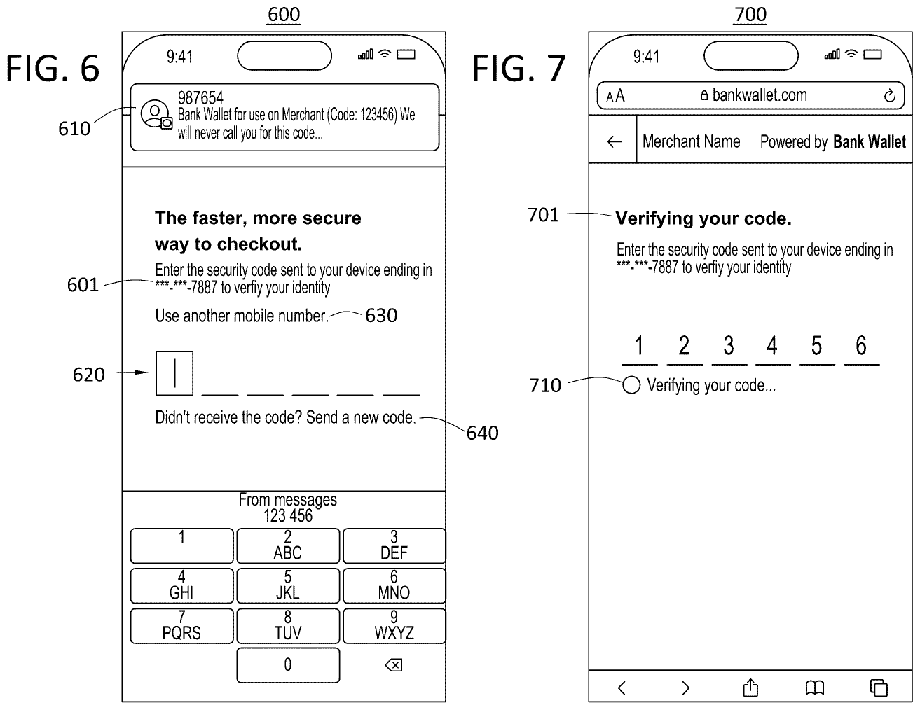

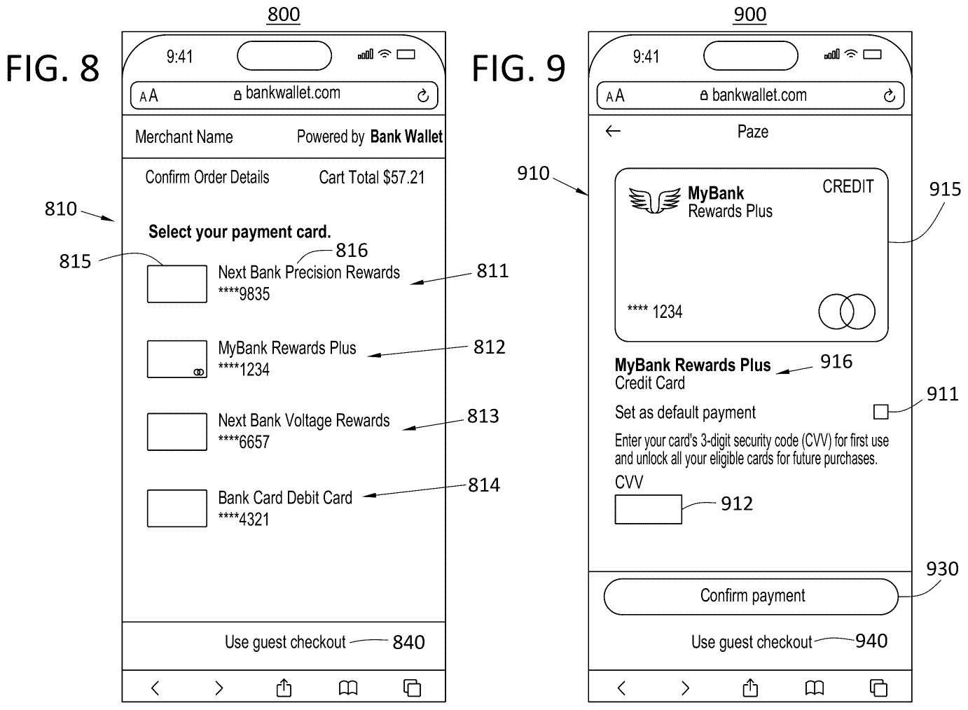

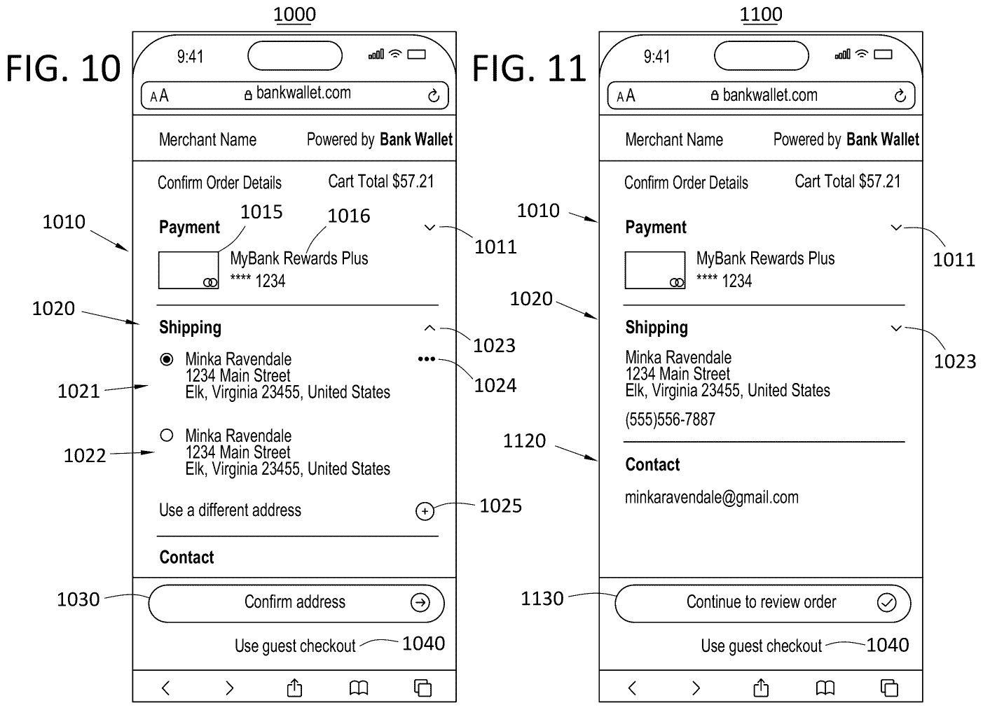

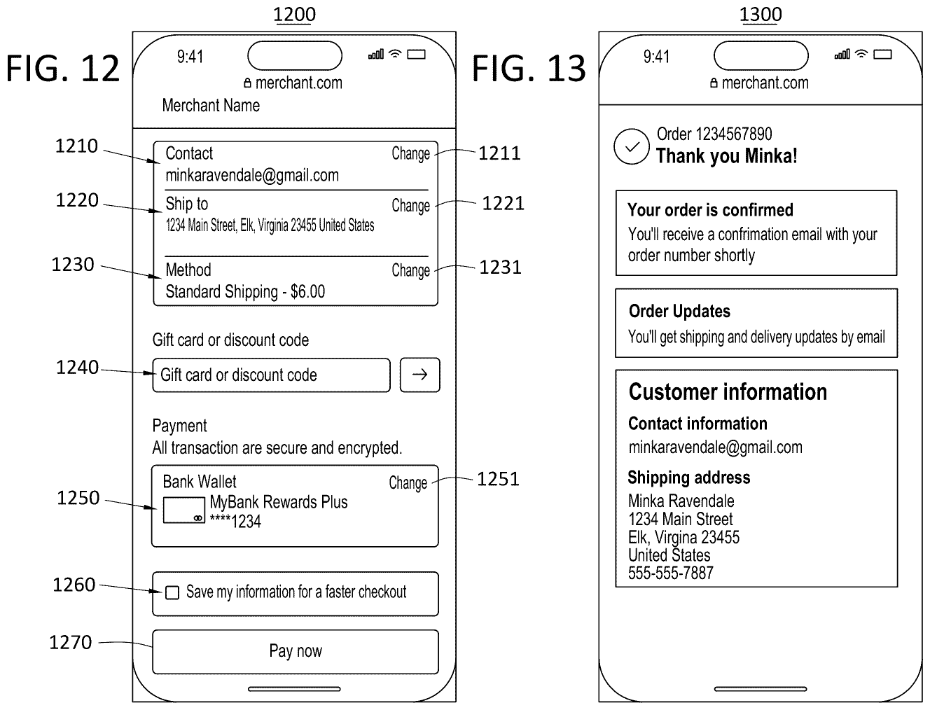

FIGS. 4-13 show a sequence of display screens 400 (FIG. 4), 500 (FIG. 5), 600 (FIG. 6), 700 (FIG. 7), 800 (FIG. 8), 900 (FIG. 9), 1000 (FIG. 10), 1100 (FIG. 11), 1200 (FIG. 12), and 1300 (FIG. 13) for a first-time checkout process for a user at a particular merchant, starting with a merchant checkout process in FIG. 4, then using the bank checkout process in FIGS. 5-11, and returning to a merchant checkout process in FIG. 12-13 based on information obtained from the bank checkout process. The flow of display screens in FIGS. 4-13 can be displayed when a user has not previously used the bank checkout process provided by wallet system 310 (FIG. 3) through a merchant (e.g., merchant system 320 (FIG. 3)). Some of these display screens also can be displayed when the user is returning to the merchant after previously successfully using the bank checkout process, as described below in further detail.

As shown in FIG. 4, display screen 400 can be displayed when a user (e.g., 340 (FIG. 3)) initiates a merchant checkout process, such as by selecting a checkout button on a merchant webpage. In many embodiments, display screen 400 can be a conventional checkout page provided by a merchant, but information entered on display screen 400 can be used in nonconventional ways to initiate a bank checkout process. Display screen 400 can include various fields that allow the user to enter information for that user, such as an email field 410, delivery method selectors 420, shipping address fields 430, and/or other suitable information. In many embodiments, information entered in one or more of these fields can be used to determine that such information is associated with a wallet that is stored in the wallet directory, such that the bank checkout process shown in FIGS. 5-9 can be initiated. For example, in some embodiments, the email address entered in email field 410 can be used to determine that there is a wallet in the wallet directory that is associated with this user. This determination can be performed once the user has finished entering information in email field 410 (which can be indicated when the user selects another field, for example) and/or can be performed when the user selects a continue button (not shown). In other embodiments, other information can be used to determine that there is a wallet associated with the user, such as a phone number entered in a phone number field (not shown). In some embodiments, when the email address or other information is known to be associated with fraud, the merchant checkout process will not initiate the bank checkout process.

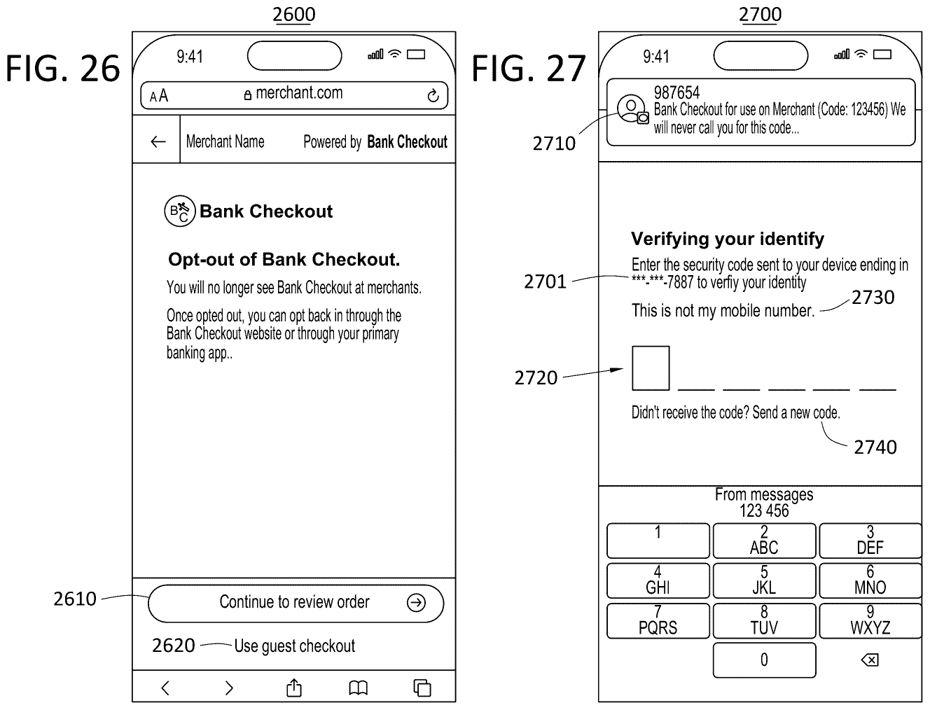

Once merchant system 320 (FIG. 3) and/or wallet system 310 (FIG. 3) determines that the bank checkout process is available to the user, based on an existing wallet associated with information entered by the user, display screen 500 shown in FIG. 5 introduces the user to the bank checkout (or bank wallet) process. In many embodiments, display screen 500 can be displayed to the user the first time the user enters the bank checkout process at each merchant, and/or until the user successfully completes a transaction using the bank checkout process at that particular merchant. Display screen 500 can include an opt-out selector 510, a consent selector 520, a terms of service selector 521, a privacy policy selector 522, a phone number field 540, a continue button 541, and/or a guest checkout selector 550. Opt-out selector 510 allows the user to initiate an opt-out process, as shown in FIGS. 26-31 and described below. Consent selector 520 can allow the user to agree to use the bank checkout process under the terms of service, privacy policy, and/or other terms and conditions or policies. In some embodiments, a toggle can be included to view or hide the service agreements. In some embodiments, the service agreements can be viewed in various languages, such as English, Spanish, etc. Terms of service selector 521 can allow the user to view terms of service for the bank checkout process. Privacy policy selector 522 can allow the user to view a privacy policy for the bank checkout process. The user can enter a phone number in the phone number field 540 and select continue button 541 to continue with the bank checkout process. Otherwise, the user can select guest checkout selector 550 to not proceed through the bank checkout process this time, but not opt-out from being presented the option in the future. When the user selects guest checkout selector 550, display screen 400 (FIG. 4) can be displayed to the user, but the bank checkout process will not be presented as an option during the remainder of the session.

When the user enters a phone number in phone number field 540 and selects continue button 541, the wallet system 310 (FIG. 3) can determine whether the phone number entered is a phone number associated with the wallet for the user, and if so, can send an authentication code, such as a one-time passcode (OTP), to the user at that phone number in order to authenticate the user. In other embodiments, a send code button (not shown) can allow the user to send the authentication code to the phone number that is already associated with the wallet, without the user entering the phone number in a phone number field (e.g., 540). This authentication code can be used to prevent a user that is a fraudster from entering an email address in email field 410 (FIG. 4) and a phone number in phone number field 540 for another individual and being able to continue the bank checkout process. If the phone number entered in phone number field 540 is not associated with the wallet, then the bank checkout process can display an error message or terminate.

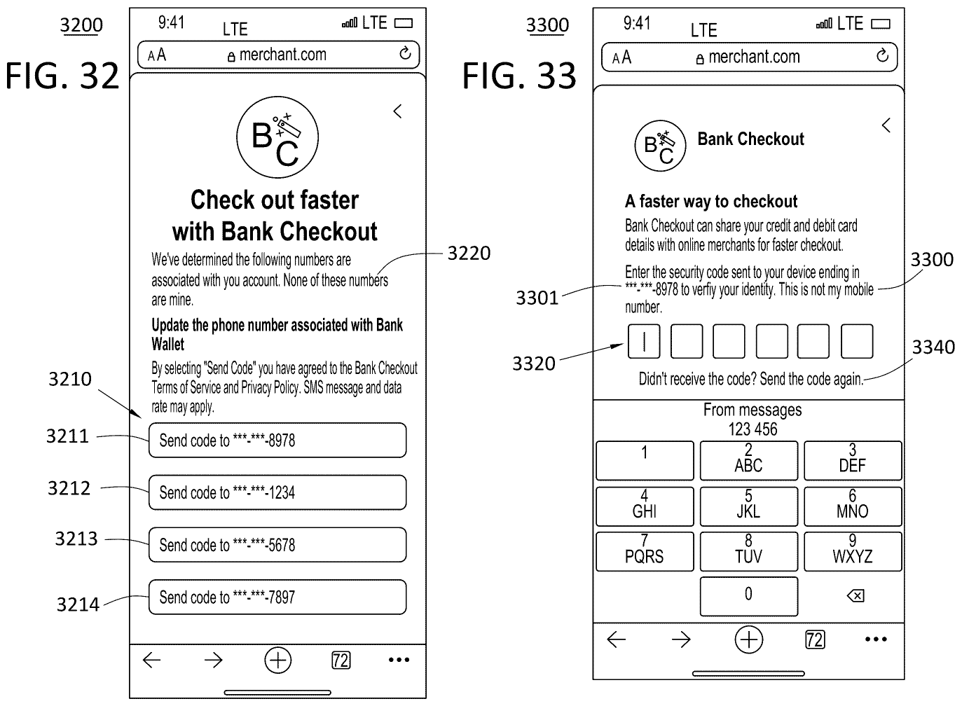

Display screen 600 of FIG. 6 shows an example of a display screen that can be shown after the user selects continue button 541 (FIG. 5). As shown in FIG. 6, a text message 610 can be sent to the mobile phone of the user (outside of the merchant checkout process and/or the bank checkout process), and text message 610 can include the authentication code. Display screen 600 can include a phone number display field 601, an authentication code field 620, a change number selector 630, and/or a new code send selector 640. Phone number display field 601 can include the phone number of the mobile phone of the user to which the authentication code was sent. In many embodiments, only a portion of the phone number is displayed in phone number display field 601, such as the last four digits of the phone number, with other digits masked. Authentication code field 620 can be used by the user can enter the authentication code received in text message 610. Change number selector 630 can be selected by the user to use a different phone number, and/or to indicate that the phone number displayed in phone number display field 601 is not the phone number associated with the user. In some embodiments, when change number selector 630 is selected, the user can be prompted to enter a different phone number, such as in phone number field 540 of FIG. 5. If the new phone number entered is associated with the wallet, then the authentication code can be sent to that new phone number, similarly as described above. In other embodiments, such as when the user did not enter the phone number originally, but instead the phone number already associated with the wallet was used, an unrecognized number process can be performed, as shown in FIGS. 32-34 and described below. New code send selector 640 can be used to have a new authentication code sent to the phone number shown (at least partially) in phone number display field 601. When new code send selector 640 is selected, display screen 600 can continue to be displayed, but with a new text message (e.g., 610) to allow the user to enter the new authentication code.

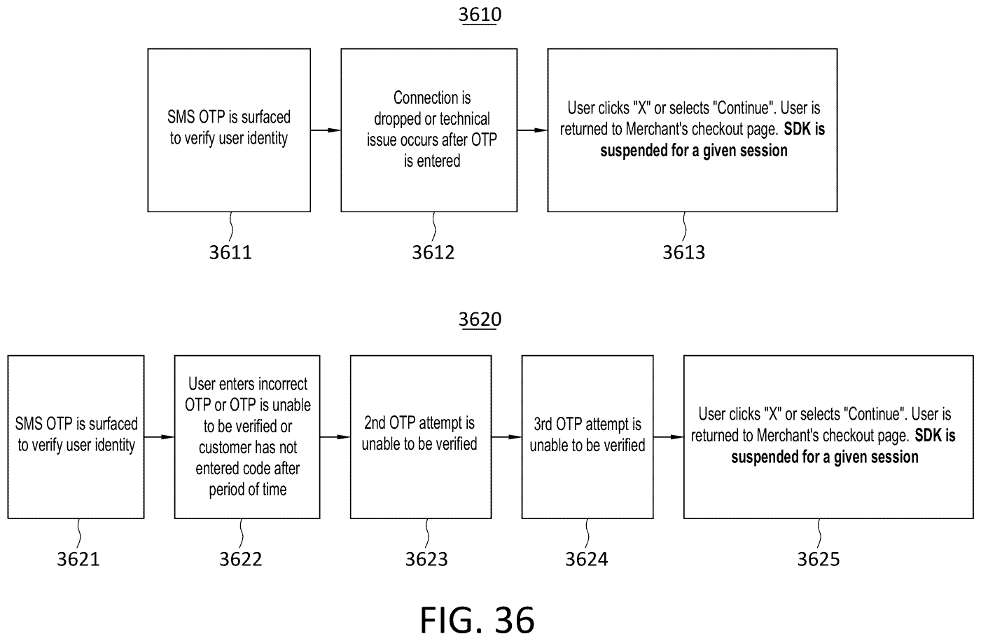

Once the authentication code is entered in authentication code field 620, the user interface can update display screen 600 to display screen 700 shown in FIG. 7, which can include a processing descriptor 701, which indicates that the code is being verified, and/or a processing indicator 710, to indicate that the authentication code has been received, and further processing is occurring. Such further processing can include determining whether the authentication code entered in authentication code field 620 (FIG. 6) matches the authentication code sent to the phone number. If the authentication code does not match, a method of handling an authentication failure can be used, such as shown in FIG. 36 and described below. In some cases, an enhanced authentication process can be used to require the user to enter additional authenticating information, such as entering the CVV (card verification value) on one of the cards associated with the wallet of the user, which can occur at this point of the process, and/or can occur later, such as shown in FIG. 9 and described below. If the authentication process completes successfully, the further processing also can include determining which payment cards are in the wallet associated with the user. If there are multiple cards associated with the wallet for this user, display screen 800, as shown in FIG. 8 and described below, can be displayed. Otherwise, if there is a single card associated with the wallet for this user, display screen 900, as shown in FIG. 9 and described below, can be displayed. In some embodiments, cards that have not had additional authenticating information entered may be greyed out, and a message can indicate “This card requires additional verification” next to such cards.

As shown in FIG. 8, display screen 800 can include a card list 810 and/or a guest checkout selector 840. Card list 810 can include multiple cards, such as cards 811-814, and can allow the user to select one of those cards to be used for this checkout transaction. Each of the cards listed can be a different card that is associated with the user in the wallet for the user in the wallet directory. These cards can all be issued by a single issuer (i.e., financial institution that issued the card) or various cards can be issued by various different issuers. For example, as shown in FIG. 8, there can be four cards issued by various banks. Card list 810 can include, for each card, a card image (e.g., 815) and/or a card descriptor (e.g., 816). Card descriptor 816 can include a name of the issuer, the card name (which in some cases includes the name of the issuer), and/or other identifying information for the card, such as the last four digits of the card number. The user can select the desired card in card list 810, after which display screen 900, as shown in FIG. 9 and described below, can be displayed, to perform additional enhanced authentication. If the user selects the guest checkout selector 840, display screen 400 (FIG. 4) can be displayed to the user, but the bank checkout process will not be presented as an option during the remainder of the session.

As shown in FIG. 9, display screen 900 can include card information 910, a default payment selector 911, a CVV field 912, a continue button 930, and/or a guest checkout selector 940. Card information 910 can include information for a single card, which can be the only card associated with the user in the wallet, or can be the card selected by the user, such as selected from card list 810 (FIG. 8). Card information 910 can include a card image 915 (which can be similar or identical to card image 815 (FIG. 8)) and/or a card descriptor 916 (which can be similar or identical to card descriptor 816 (FIG. 8)). Default payment selector 911 can be used to allow the user to set the card shown in card information 910 as the default card to be used when using the bank checkout process, even at different merchants. CVV field 912 can be used by the user to input the CVV for the card. In many embodiments, the CVV can be required as an additional form of authentication to proceed with payment using the card. After the user has entered the CVV in CVV field 912, the user can select continue button 930. If the CVV is authenticated, display screen 1000, as shown in FIG. 10 and described below, can be displayed. Otherwise, an error can be displayed and/or the bank checkout process can terminate. Guest checkout selector 940 can be similar or identical to guest checkout selector 840.

As shown in FIG. 10, display screen 1000 can include card information 1010, shipping information 1020, a confirm address button 1030, and/or a guest checkout selector 1040. Card information 1010 can include information for the card for which the CVV was authenticated, as described above in connection with FIG. 9. Card information 1010 can include a card image 1015 (which can be similar or identical to card image 815 (FIG. 8) and/or card image 915 (FIG. 9)) and/or a card descriptor 1016 (which can be similar or identical to card descriptor 816 (FIG. 8) and/or card descriptor 916 (FIG. 9)). In some embodiments, such as when there are multiple cards, a card selector 1011 can be used to allow the user to select a different card. For example, when card selector 1011 is selected by the user, display screen 800 (FIG. 8) can be displayed to allow the user to select another card.

Shipping information 1020 can include one or more shipping options, such as shipping options 1021-1022, to allow the user to select one of the shipping options as the shipping method for this payment. Shipping information 1020 can toggle between (i) displaying the default or selected shipping option (as shown in FIG. 11, described below), and (ii) showing a list of shipping options (as shown in FIG. 10), by using a shipping option display selector 1023. The wallet for the user can store various shipping addresses, which can be one or more addresses for the user that are associated with the cards, so that the user can readily select these stored addresses, even at different merchants. An existing shipping option (e.g., 1021) can be modified using a shipping modification selector 1024, and/or other addresses entered by the user, such as through an add shipping address selector 1025. When the user selects add shipping address selector 1025, the add different shipping address process shown in FIGS. 21-23 and described below, can be displayed. After the user has reviewed, updated, and/or confirmed the shipping information shown in shipping information 1020, the user can select confirm address button 1030, after which display screen 1100, as shown in FIG. 11 and described below, can be displayed. Guest checkout selector 1040 can be similar or identical to guest checkout selector 840 (FIG. 8).

As shown in FIG. 11, display screen 1100 can be an update of display screen 1000 (FIG. 10) after the user has confirmed the shipping address. Display screen 1100 can include card information 1010, shipping information 1020, contact information 1120, a continue button 1130, and/or guest checkout selector 1040. Shipping information 1020 can include the shipping option confirmed in display screen 1000 (FIG. 10). Contact information 1120 can include an email address or phone number for contacting the user, which can be based on the email address entered in email field 410 (FIG. 4) and/or phone number field 540 (FIG. 5). After the user has confirmed the order details in display screen 1100, the user can select continue button 1130, after which display screen 1200, as shown in FIG. 12 and described below, can be displayed. FIG. 11 ends the display screens provided by the SDK for the bank checkout process and FIG. 12 returns to the display screens of the merchant checkout process.

Display screen 1200 is provided by the merchant (e.g., merchant system 320 (FIG. 3)) as part of the merchant checkout process, with information provided to merchant system 320 (FIG. 3) from wallet system 310 (FIG. 3) based on the information entered and confirmed by the user in the bank checkout process (as described above in connection with FIGS. 5-11). As shown in FIG. 12, display screen 1200 can include contact information 1210, shipping information 1220, shipping method information 1230, discount field 1240, card information 1250, a save information selector 1260, and an order button 1270.

Contact information 1210 can display the email address and/or phone number associated with the user, which can be received by merchant system 320 (FIG. 3) from wallet system 310 (FIG. 3) based on the email address and/or phone number associated with the user in the wallet for the user, and/or can be populated based on the email address entered by the user in email field 410 (FIG. 4). If the user desires to change the contact information, an edit contact selector 1211 can be selected, which in some embodiments can result in returning to the bank checkout process, or instead can result in changing the contact information in the manner used conventionally in the merchant checkout process for that merchant.

Shipping information 1220 can be populated based on the shipping option confirmed in FIG. 10 and shown in shipping information 1020 in FIG. 11. If the user desires to change the shipping information, an edit shipping selector 1221 can be selected, which in some embodiments can result in returning to the bank checkout process, or instead can result in changing the shipping information in the manner used conventionally in the merchant checkout process for that merchant.

Card information 1250 can be populated based on the card selected, authenticated, and/or confirmed by the user in the bank checkout process, such as confirmed in card information 1010 in FIGS. 10-11. Card information 1250 shows information about the card that will be used for the transaction once the order is placed. The merchant (e.g., merchant system 320 (FIG. 3)) can receive this card information, and/or a token cryptogram to process the payment using this card, from wallet system 310 (FIG. 3) based on the card selected in the bank checkout process. If the user desires to change the card, a change card selector 1251 can be selected, which in some embodiments can result in returning to the bank checkout process and displaying display screen 800 (FIG. 8), or instead can result in changing the card information in the manner used conventionally in the merchant checkout process for that merchant. In some embodiments, a visual indicator can indicate whether or not the card is setup for use through the bank checkout process.

Shipping method information 1230 can show the shipping method to be used by the merchant, which can be updated using a shipping method change selector 1231. Discount field 1240 can allow the user to enter a discount code or gift card for the merchant. Save information selector 1260 can allow the user to save the contact, shipping, and/or card information with the merchant for future checkouts with the merchant. In some embodiments, additional checkout information can be included, such as subtotal, taxes, total amount, and/or other suitable information. Order button 1270 can be used to request that the transaction be processed using the card shown in card information 1250. When order button 1270 is selected by the user, the payment can be processed, after which a receipt can be displayed to the user, such as shown in display screen 1300 of FIG. 13.

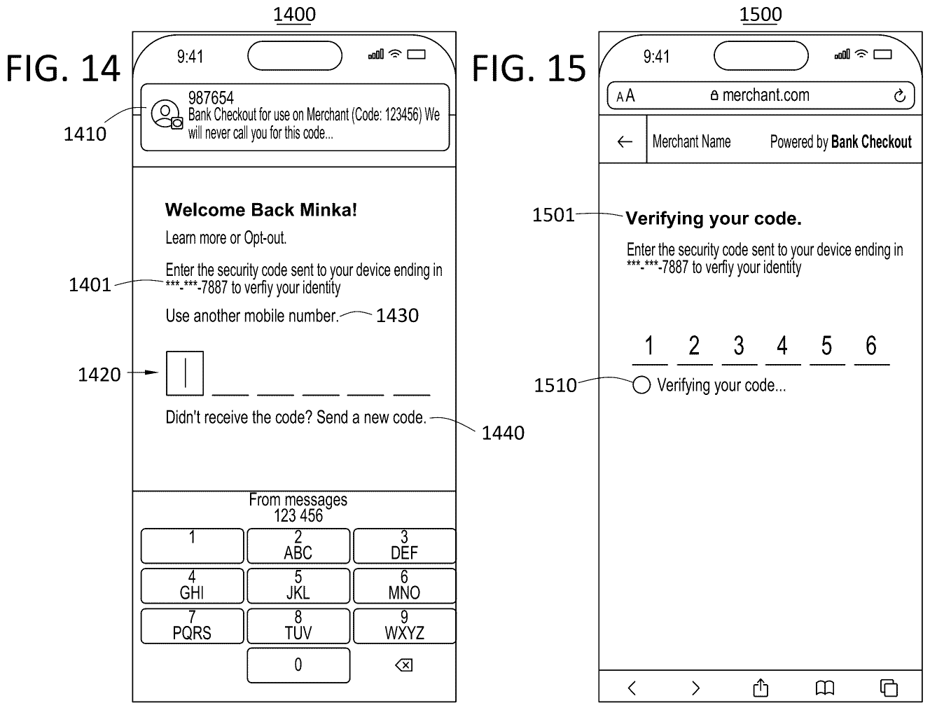

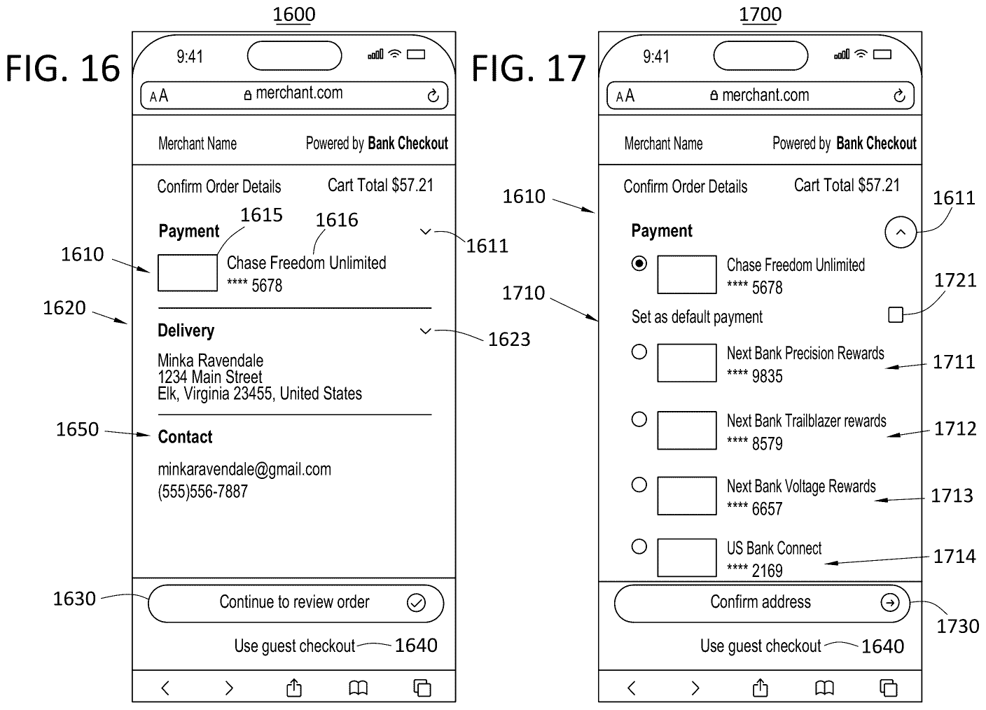

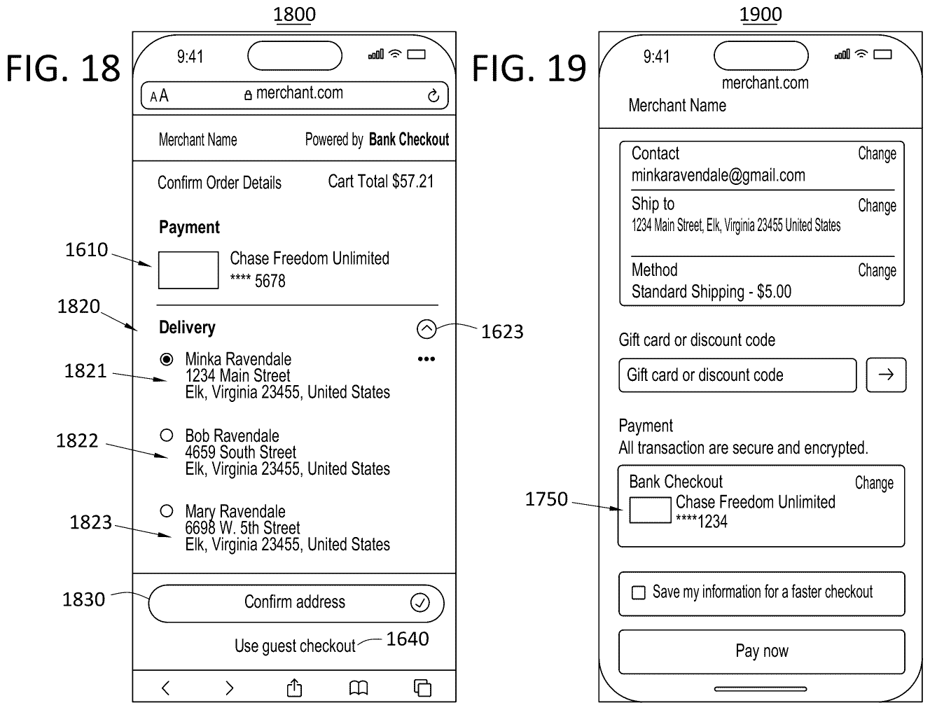

FIGS. 4 and 14-19 show a sequence of display screens 400 (FIG. 4), 1400 (FIG. 14), 1500 (FIG. 15), 1600 (FIG. 16), 1700 (FIG. 17), 1800 (FIG. 18), and 1900 (FIG. 19) for a checkout process for a returning user, as well as showing how to modify the card used and how to modify shipping information. For a retuning visit to the online checkout process of the merchant, when the user enters identifying information in the merchant checkout process (e.g., in display screen 400 (FIG. 4)), the SDK can determine that the user has successfully completed a transaction previously using the bank checkout process. In many embodiments, display screen 500 (FIG. 5) can be skipped, and instead display screen 1400 of FIG. 14 can be displayed.

As shown in FIG. 14, a text message 1410 can be sent to the mobile phone of the user (outside of the merchant checkout process and/or the bank checkout process), and text message 1410 can include the authentication code. Text message 1410 can be similar to text message 610 (FIG. 6). Display screen 1400 can include a phone number display field 1401, an authentication code field 1420, a change number selector 1430, and/or a new code send selector 1440. Phone number display field 1401 can be similar or identical to phone number display field 601 (FIG. 6), authentication code field 1420 can be similar or identical to authentication code field 620 (FIG. 6), change number selector 1430 can be similar or identical to change number selector 630 (FIG. 6), and new code send selector 1440 can be similar or identical to new code send selector 640 (FIG. 6). The user can enter the authentication code received in text message 1410 into authentication code field 1420.

Once the authentication code is entered in authentication code field 1420, the user interface can update display screen 1400 to display screen 1500 shown in FIG. 15, which can include a processing descriptor 1501, which indicates that the code is being verified, and/or a processing indicator 1510, to indicate that the authentication code has been received, and further processing is occurring. Processing descriptor 1501 can be similar or identical to processing descriptor 701 (FIG. 7), and processing indicator 1510 can be similar or identical to processing indicator 710 (FIG. 7). Such further processing can include determining whether the authentication code entered in authentication code field 1420 (FIG. 14) matches the authentication code sent to the phone number. If the authentication code does not match, a method of handling an authentication failure can be used, such as shown in FIG. 36 and described below. In some embodiments, additional enhanced authentication can be used, such as described above. If the authentication process completes successfully, the further processing also can include retrieving the payment card and shipping information default information for the wallet associated with the user. In many embodiments, the card that was selected in card list 810 (FIG. 8) during the initial visit can be used as the “default” card for the returning visit, and even when there are multiple cards associated with the wallet for the user, showing the list of payment card options (e.g., as in display screen 800 (FIG. 8)) can be skipped, instead showing display screen 1600 (FIG. 16) with the default card shown in card information 1610 (FIG. 16).

As shown in FIG. 16, display screen 1600 can include card information 1610, shipping information 1620, contact information 1650, a continue button 1630, and/or a guest checkout selector 1640. Card information 1610 can be similar or identical to card information 1010 (FIGS. 10-11). Shipping information 1620 can be similar or identical to shipping information 1020 (FIGS. 10-11). Contact information 1650 can be similar or identical to contact information 1120 (FIG. 11). Continue button 1630 can be similar or identical to continue button 1130 (FIG. 11). Guest checkout selector 1640 can be similar or identical to guest checkout selector 1040 (FIGS. 10-11). Card information 1610 can include information for the default card. Card information 1610 can include a card image 1615 (which can be similar or identical to card image 815 (FIG. 8)) and/or a card descriptor 1616 (which can be similar or identical to card descriptor 816 (FIG. 8)). In some embodiments, such as when there are multiple cards, a card selector 1611 (which can be similar or identical to card selector 1011 (FIGS. 10-11)) can be used to allow the user to select a different card. For example, when card selector 1611 is selected by the user, display screen 1700 (FIG. 17, described below) can be displayed to allow the user to select another card. A shipping option display selector 1623 (which can be similar or identical to shipping option display selector 1023 (FIGS. 10-11)) can be used to toggle between displaying additional shipping options, as shown in display screen 1800 (FIG. 18, described below).

As shown in FIG. 17, display screen 1700 shows an update of display screen 1600 when the user toggles card selector 1611. In addition to card information 1610, display screen 1700 can include a card list 1710. Card list 1710 can include other cards, such as cards 1711-1714, and can allow the user to select one of those cards to be used for this checkout transaction. Each of the cards listed can be a different card that is associated with the user in the wallet for the user in the wallet directory. These cards can all be issued by a single issuer (i.e., financial institution that issued the card) or various cards can be issued various different issuers. The user can select the desired card in card list 1710, and can select a confirm card button 1730 to confirm using the selected card, after which the display can return to display screen 1600 (FIG. 16) (but with a different card in card information 1610, if a different card was selected in display screen 1700). Display screen 1700 also can include a default payment selector 1721 (which can be similar to default payment selector 911 (FIG. 9)) to allow the user to select a card as a default card.

As shown in FIG. 18, display screen 1800 shows an update of display screen 1600 when the user toggles shipping option display selector 1623. Shipping information 1620 (FIG. 16) can be updated to show shipping information 1820, which can list multiple shipping options, such as shipping options 1821-1823. Shipping information 1820 can be similar to shipping information 1020 (FIG. 10). The user can select the desired shipping address in shipping information 1820, and can select a confirm address button 1830 to confirm using the selected shipping address, after which the display can return to display screen 1600 in FIG. 16 (but with a different shipping address in shipping information 1620, if a different shipping address was selected in display screen 1800).

After the user selects continue button 1630 in FIG. 16, display screen 1900 of FIG. 19 can be displayed. Display screen 1900 can be similar to display screen 1200 (FIG. 12), and various elements of display screen 1900 can be similar or identical to various elements of display screen 1200 (FIG. 12). Display screen 1900 can include card information in card information 1950 that is different from card information 1250 in display screen 1200 (FIG. 12).

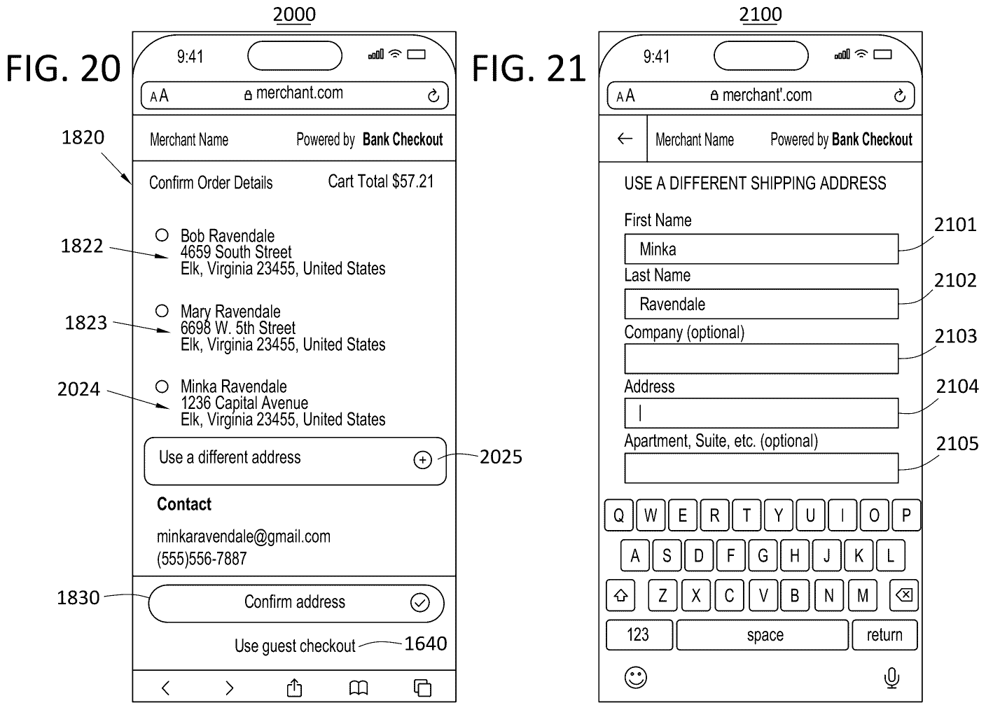

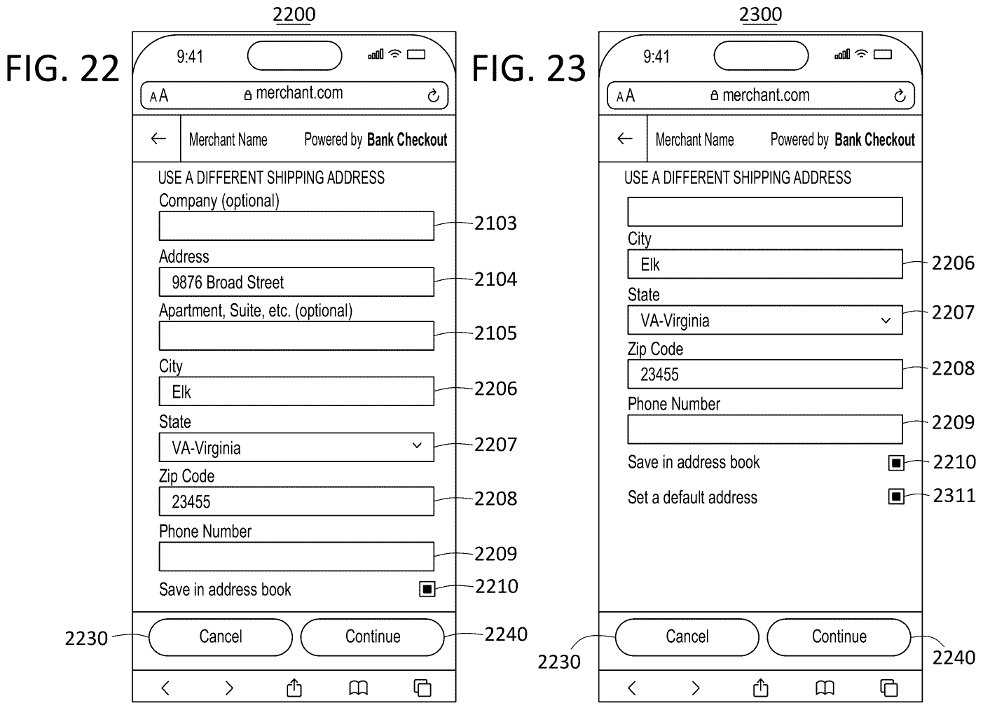

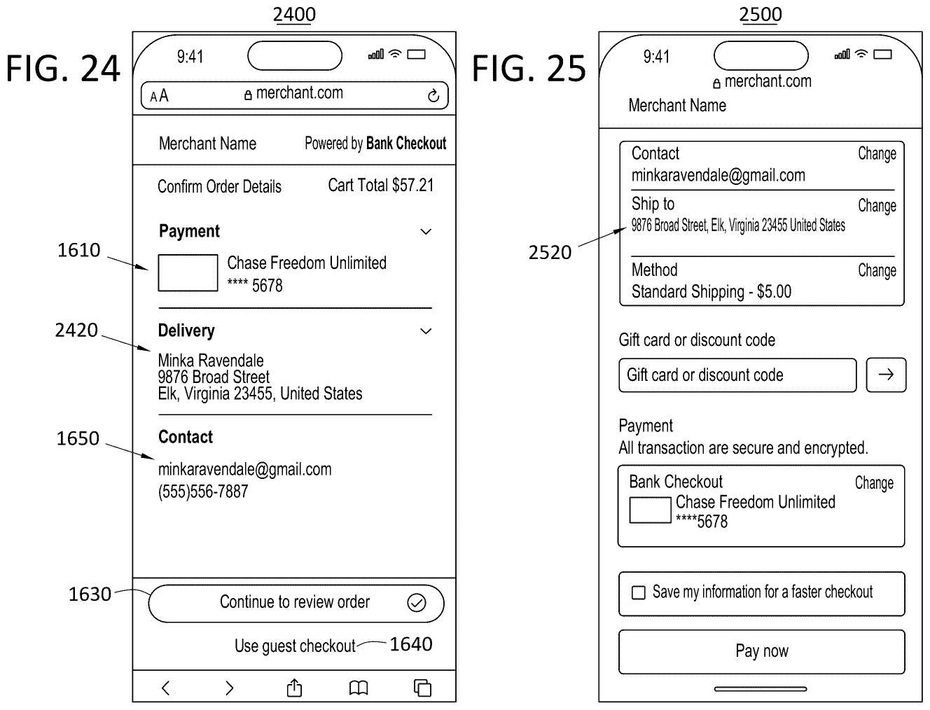

FIGS. 4, 14-16, 18, and 20-25 show a sequence of display screens 400 (FIG. 4), 1400 (FIG. 14), 1500 (FIG. 15), 1600 (FIG. 16), 1800 (FIG. 18), 2000 (FIG. 20), 2100 (FIG. 21), 2200 (FIG. 22), 2300 (FIG. 23), 2400 (FIG. 24), and 2500 (FIG. 25) for a checkout process for a returning user, in which the user adds a different shipping address. On display screen 1800 of FIG. 18, the user can scroll down to show additional shipping options within shipping information 1820. Display screen 2000 of FIG. 20 shows an update to display screen 1800 (FIG. 18), showing additional shipping information 1820, such as also displaying a shipping option 2024. Additionally, an add shipping address selector 2025 can be displayed on display screen 2000, which can be used by the user to add a different shipping address than the ones listed in shipping information 1820. Add shipping address selector 2025 can be similar or identical to add shipping address selector 1025 (FIG. 10). When add shipping address selector 2025 is selected, display screen 2100 of FIG. 21 can be displayed.

As shown in FIGS. 21-23, a page can be displayed to allow the user to input a different shipping address, and this page is displayed in multiple portions, while scrolling downward, in display screens 2100 (FIG. 21), 2200 (FIG. 22), and 2300 (FIG. 23). The page shown in display screens 2100, 2200, and 2300 can include various input fields for the new address information, such as a first name field 2101, a last name field 2102, a company field 2103, an address field 2104, an apartment field 2105, a city field 2206, a state field 2207, a zip code field 2208, and a phone number field 2209. In some embodiments, a save address selector 2210, a set default selector 2311 can be included. Save address selector 2210 can allow the user to indicate whether this new address should be saved in the wallet, so that the address can be selected later when the user uses the bank checkout process at this same merchant and/or at different merchants. Set default selector 2311 can allow the user to indicate whether this address is the primary (e.g., “default”) address to use for this user in future transactions in the bank checkout process at this same merchant and/or at different merchants. Once the input fields are input, and the selections of the user for save address selector 2210 and/or set default selector 2311 are indicated, the user can select a continue button 2240, after which the display can return to display screen 1600 (FIG. 16) (but with a different address in shipping information 1620, if a different address was entered in display screens 2100, 2200, and 2300), such as shown in display screen 2400 (FIG. 24, described below). Otherwise, a cancel button 2230 can be selected to exit adding a new shipping address. As shown in FIG. 24, display screen 2400 shows an update to display screen 1600 (FIG. 16), in which shipping information 1620 is replaced with shipping information 2420, based on the new address entered as shown in FIGS. 21-23. After the user selects continue button 1630 in FIG. 24, display screen 2500 of FIG. 25 can be displayed. Display screen 2500 can be similar to display screen 1200 (FIG. 12) and/or display screen 1900 (FIG. 19), and various elements of display screen 2500 can be similar or identical to various elements of display screen 1200 (FIG. 12) and/or display screen 1900 (FIG. 19). Display screen 2500 can include shipping information in shipping information 2520 that is different from shipping information 1220 in display screen 1200 (FIG. 12).

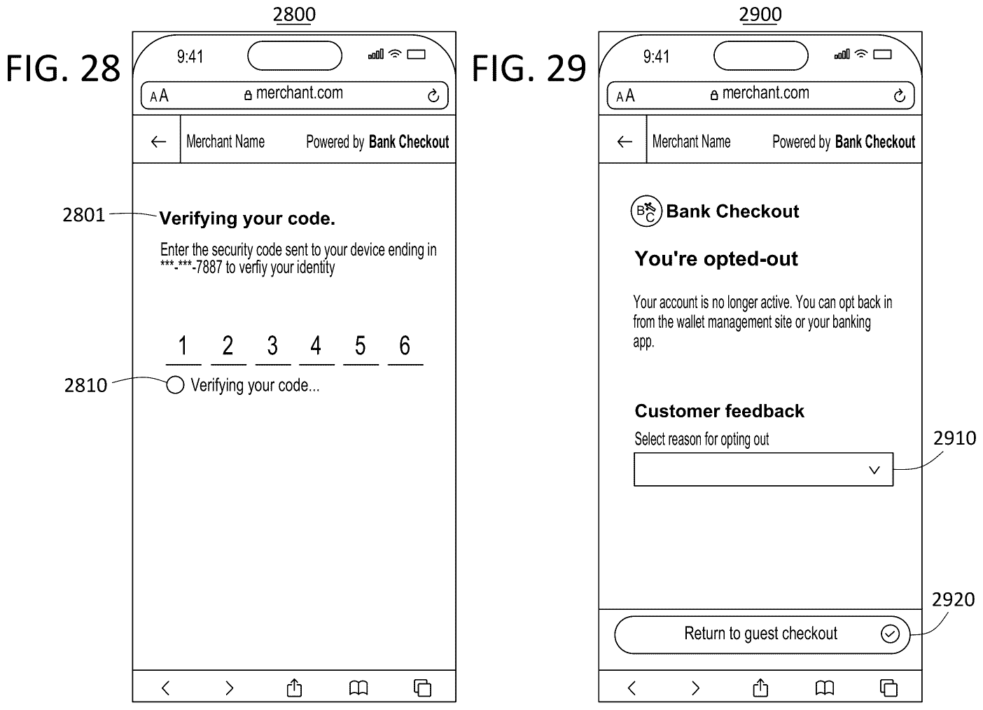

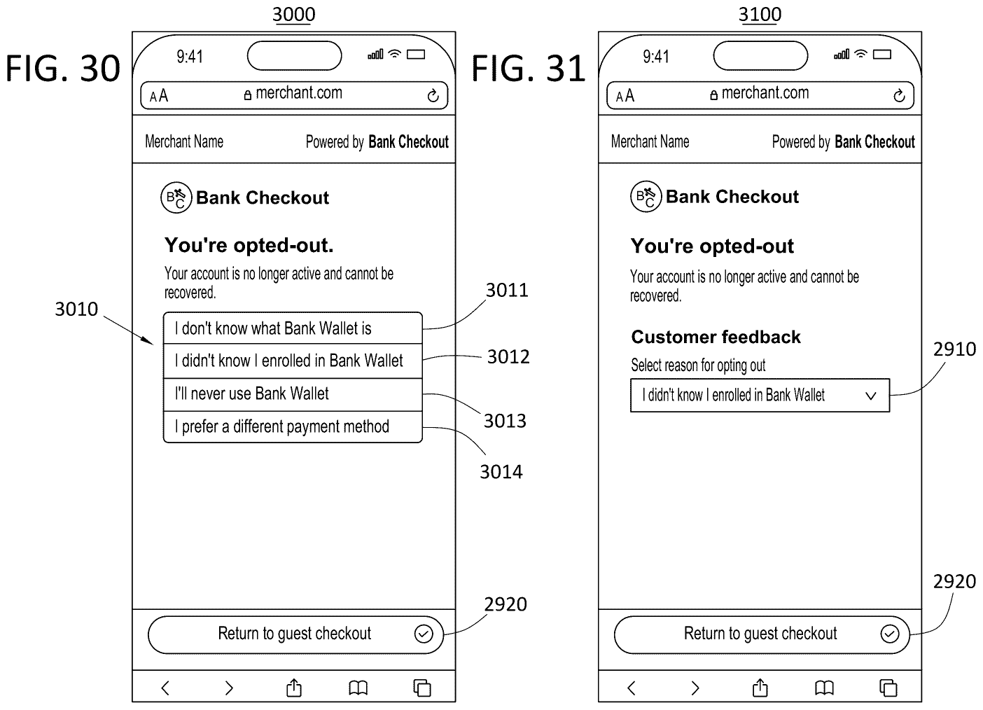

FIGS. 4-5 and 26-31 show a sequence of display screens 400 (FIG. 4), 500 (FIG. 5), 2600 (FIG. 26), 2700 (FIG. 27), 2800 (FIG. 28), 2900 (FIG. 29), 3000 (FIG. 30), and 3100 (FIG. 31) for an opt-out process. In many embodiments, if the user selects opt-out selector 510 of FIG. 5, then display screen 2600 of FIG. 26 can be displayed to initiate an opt-out process. As shown in FIG. 26, display screen 2600 can include information about opting out of using bank checkout, which can delete the wallet associated with the user from the wallet directory. Display screen 2600 can include an opt-out button 2610, by which the user can confirm that the user desires to delete the wallet associated with the user, and a return button, by which the user can return to bank checkout, such as returning to display screen 500 (FIG. 5). When the user selects opt-out button 2610, an authentication code can be sent to the user to authenticate the identity of the user.

As shown in FIG. 27, a text message 2710 can be sent to the mobile phone of the user (outside of the merchant checkout process and/or the bank checkout process), and text message 2710 can include the authentication code. Text message 2710 can be similar to text message 610 (FIG. 6) and/or text message 1410 (FIG. 14). Display screen 2700 can include a phone number display field 2701, an authentication code field 2720, a change number selector 2730, and/or a new code send selector 2740. Phone number display field 2701 can be similar or identical to phone number display field 601 (FIG. 6) and/or phone number display field 1401 (FIG. 14), authentication code field 2720 can be similar or identical to authentication code field 620 (FIG. 6) and/or authentication code field 1420 (FIG. 14), change number selector 2730 can be similar or identical to change number selector 630 (FIG. 6) and/or change number selector 1430 (FIG. 14), and new code send selector 2740 can be similar or identical to new code send selector 640 (FIG. 6) and/or new code send selector 1440 (FIG. 14). The user can enter the authentication code received in text message 2710 into authentication code field 2720.

Once the authentication code is entered in authentication code field 2720, the user interface can update display screen 2700 to display screen 2800 shown in FIG. 28, which can include a processing descriptor 2801, which indicates that the code is being verified, and/or a processing indicator 2810, to indicate that the authentication code has been received, and further processing is occurring. Processing descriptor 2801 can be similar or identical to processing descriptor 701 (FIG. 7) and/or processing descriptor 1501 (FIG. 15), and processing indicator 2810 can be similar or identical to processing indicator 710 (FIG. 7) and/or processing indicator 1510 (FIG. 15). Such further processing can include determining whether the authentication code entered in authentication code field 2720 (FIG. 27) matches the authentication code sent to the phone number. If the authentication code does not match, a method of handling an authentication failure can be used, such as shown in FIG. 36 and described below. In some embodiments, additional enhanced authentication can be used, such as described above. If the authentication process completes successfully, the wallet associated with the user can be deleted from the wallet directory, and display screen 2900 of FIG. 29 can be displayed to the user.

As shown in FIGS. 29-31, a page can be displayed to notify the user that the user has been successfully opted out of using the bank checkout, and allow the user to select a reason for opting out. The page shown in display screen 2900 (FIG. 29) can include a reason field 2910, which, when selected, can update to show a list 3010 of reasons, such as reasons 3011-3014, as shown in display screen 3000 (FIG. 30). When the user selects a reason, reason field 2910 can be updated, as shown in FIG. 31. The user can select a return to merchant button 2920 to return to the merchant checkout process, such as display screen 400 (FIG. 4), after which the bank checkout process will not be presented as an option unless the user later enrolls in the bank checkout.

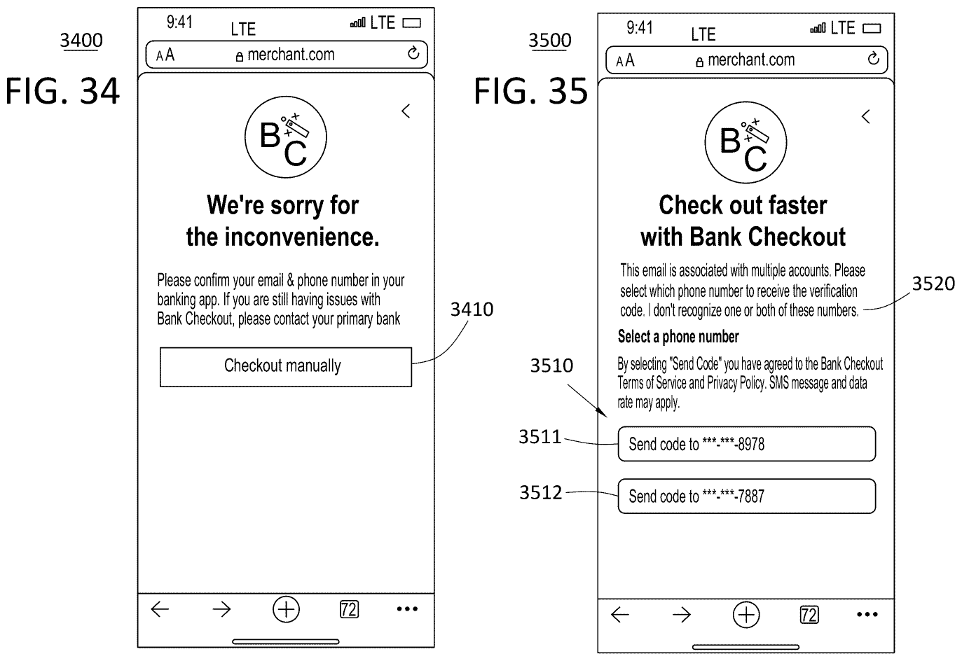

FIGS. 32-34 show two different options of an unrecognized number process. In some embodiments, a first option of the unrecognized number process includes a sequence of display screens 3200 (FIG. 32) and 3300 (FIG. 33). In other embodiments, a second option of the unrecognized number process includes a display screen 3400 (FIG. 34). In yet other embodiments, another suitable unrecognized number process can be used. In some embodiments, the unrecognized number process can be performed when the user indicates that the number to which the authentication code was sent is not recognized, such as when the user selected change number selector 630 (FIG. 6), change number selector 1430 (FIG. 14), and/or change number selector 2730 (FIG. 27).

In the first option of the unrecognized number process, as shown in FIGS. 32-33, the user is presented with one or more other phone numbers that also are associated with the user in the wallet, such as based on information received from the issuers about the phone numbers associated with the cards issued by the issuers to the user. As shown in FIG. 32, display screen 3200 can include a phone number list 3210 and a none selector 3220. Phone number list 3210 can include phone number options (e.g., 3211-3214). Each of phone number options 3211-3214 shows a different phone number (or a portion thereof, such as the last four digits of the phone number) that is associated with the user in the wallet for the user. The user can select one of phone number options 3211-3214 to have the authentication code sent to that phone number. For example, the user can select phone number option 3211 to send the authentication code to a different phone number ending in 8978. None selector 3220 can be selected by the user when none of the phone numbers listed in phone number list 3210 are recognized by the user. In some embodiments, if the user selects none selector 3220, display screen 3400, as shown in FIG. 34 and described below, can be displayed.

Display screen 3300 of FIG. 33 shows an example of a display screen that can be shown after the user selects one of the phone number options in phone number list 3210 (FIG. 32). Display screen 3300 can be similar to display screen FIG. 6 (FIG. 6), and various elements of display screen 3300 can be similar or identical to various elements of display screen 600 (FIG. 6). A text message (not shown) can be sent to the mobile phone of the user (outside of the merchant checkout process and/or the bank checkout process), and the text message can include the authentication code. The text message can be similar to text message 610 (FIG. 6). Display screen 3300 can include a phone number display field 3301, an authentication code field 3320, a change number selector 3330, and/or a code resend selector 3340. Phone number display field 3301 can be similar to phone number display field 601 (FIG. 6) (but can display a different phone number), authentication code field 3320 can be similar or identical to authentication code field 620 (FIG. 6), change number selector 3330 can be similar or identical to change number selector 630 (FIG. 6), and code resend selector 3340 can be similar or identical to new code send selector 640 (FIG. 6). When the authentication code is entered and the authentication code matches, the flow can continue similarly as described above in connection with FIG. 7, FIG. 15, and/or FIG. 28. If the authentication code does not match, a method of handling an authentication failure can be used, such as shown in FIG. 36 and described below.

In the second option of the unrecognized number process, as shown in FIG. 34, display screen 3400 is displayed, which informs the user that the bank checkout process is not available to the user. This option can be displayed when there was only one phone number associated with the user, and the user previously indicated that such phone number was unrecognized. In some embodiments, this option can be displayed when there are other phone numbers associated with the user that are not the primary phone number and that the user did not recognize, but those alternate numbers are not displayed to the user. This option can prevent the user from changing the primary phone number associated with the user in the wallet to another phone number. In some embodiments, this second option of the unrecognized number process can be displayed when the user selects change number selector 630 (FIG. 6) in a second option of handling a shared email address across multiple different wallets, as described below in connection with FIG. 35. As shown in FIG. 34, display screen 3400 can include a manual checkout button 3410. If the user selects the manual checkout button 3410, display screen 400 (FIG. 4), but the bank checkout process will not be presented as an option for this session.

FIG. 35 shows a first option of handling a shared email address across multiple different wallets, which includes display screen 3500 (FIG. 35). Alternatively, a second option of handling a shared email address across multiple different wallets can be used, such as selecting a primary (e.g., first) wallet associated with that email address, and using the primary phone number associated with the wallet to follow the process shown in FIGS. 5-6. When the user selects change number selector 630 (FIG. 6) in this second option of handling the shared email address across multiple different wallets, display screen 3400 (FIG. 34) can be shown, which can prevent the user from using the bank checkout process for another wallet that is not the primary wallet for that email address. In other embodiments, other suitable options of handling a shared email address across multiple different wallets can be used. The handling a shared email address across multiple different wallets can be performed when the user inputs an email address for the user, such as in email field 410 of FIG. 4, and the wallet system (e.g., 310 (FIG. 3)) determines there are multiple wallets associated with that email address. This situation can occur when an email address is used by multiple different people, and that email address is associated with separate wallets in the wallet directory, such as spouses share an email address, as an example.

In the first option of handling a shared email address across multiple different wallets, as shown in FIG. 35, the user is presented with multiple phone numbers for the wallets that are associated with the email address. For example, these phone numbers can be the primary phone number for each wallet associated with the email address. In other embodiments, alternative phone numbers for the wallets can be shown as well. As shown in FIG. 35, display screen 3500 can include a phone number list 3510 and a none selector 3520. Display screen 3500 can be similar to display screen 3200 (FIG. 32), and various elements of display screen 3500 can be similar or identical to various elements of display screen 3200 (FIG. 32). Phone number list 3510 can be similar to phone number list 3210 (FIG. 32), and none selector 3520 can be similar or identical to none selector 3220 (FIG. 32). Phone number list 3510 can include phone number options (e.g., 3511-3512). Phone number options 3511-3512 can be similar to phone number options 3211-3214 (FIG. 32). Each of phone number options 3511-3512 shows a different phone number (or a portion thereof, such as the last four digits of the phone number) that is associated with a wallet that is associated with the email address entered by the user. For example, phone number option 3511 can be associated with a first wallet in the wallet directory, and phone number option 3512 can be associated with a second wallet in the wallet directory. The user can select one of phone number options 3511-3512 to indicate which wallet is associated with the user and to have the authentication code sent to that phone number. For example, the user can select phone number option 3512 to send the authentication code to a phone number ending in 7887. None selector 3520 can be selected by the user when none of the phone numbers listed in phone number list 3510 are recognized by the user. In some embodiments, if the user selects none selector 3520, display screen 3400 (FIG. 34) can be displayed.

After the user selects one of the phone number options in phone number list 3510 (FIG. 35), an authentication process can be used, which can be similar or identical to display screen 600 (FIG. 6), display screen 1400 (FIG. 14), and/or display screen 2700 (FIG. 27). When the authentication code is entered and the authentication code matches, in some embodiments, an enhanced authentication process can be used, and once authenticated, the flow can continue similarly as described above in connection with FIG. 8. If the authentication code does not match, a method of handling an authentication failure can be used, such as shown in FIG. 36 and described below.

In many embodiments, the first option of handling a shared email address across multiple different wallets, as shown in FIG. 35, can be used when none of the wallets associated with the email address have been used previously in the bank checkout process. Once one of the wallets is associated with the email address, such as through the process shown in FIG. 35, a second user that enters that email address can be notified that the email address is already in use with a different wallet, and suggest that the second user update the email address associated with the wallet for the second user.

Turning ahead in the drawings, FIG. 36 illustrates flow charts for methods 3610 and 3620 of handling an authentication failure, according to two embodiments. Methods 3610 and 3620 are merely exemplary and are not limited to the embodiments presented herein. Methods 3610 and/or 3620 can be employed in many different embodiments or examples not specifically depicted or described herein. In some embodiments, the procedures, the processes, and/or the activities of methods 3610 and/or 3620 can be performed in the order presented. In other embodiments, the procedures, the processes, and/or the activities of methods 3610 and/or 3620 can be performed in any suitable order. In still other embodiments, one or more of the procedures, the processes, and/or the activities of methods 3610 and/or 3620 can be combined or skipped.

Referring to FIG. 36, method 3610 can begin with an activity 3611 of displaying (e.g., “surfacing”) an authentication code (such as an SMS (Short Message Service) OTP) to the user. This authentication code can be sent to the user in a text message, such as text message 610 (FIG. 6), text message 1410 (FIG. 14), and/or text message 2710 (FIG. 27). The user can be prompted to enter this authentication code, such in display screen 600 (FIG. 6), display screen 1400 (FIG. 14), and/or display screen 2700 (FIG. 2700).

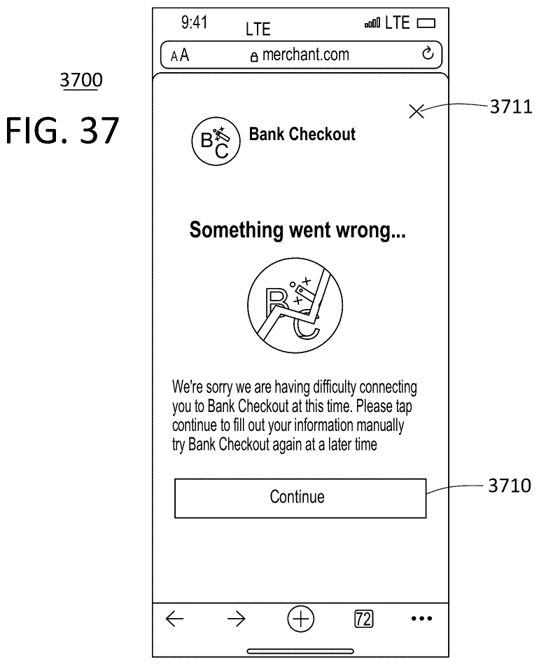

Next, method 3610 can include an activity 3612 of detecting that a connection to the user is dropped or there is another technical issue that occurs. This dropped connection or technical issue could be displayed to the user, or not displayed to the user. Once the dropped connection or technical issue is detected, display screen 3700 of FIG. 37 can be displayed, which can indicate to the user that something went wrong. Display screen 3700 can include a continue button 3710 and a close button 3711.

Returning to FIG. 36, method 3610 next can include an activity 3613 of detecting that the user has acknowledged the issue and returning to the merchant checkout page. If the user closes out of the display screen by selecting continue button 3710 (FIG. 37) or selecting close button 3711 (FIG. 37), the user can be returned to the merchant checkout page, such as by displaying display screen 400 (FIG. 4). The bank checkout process can be suspended and not used for the remainder of that session.

Referring next to method 3620 in FIG. 36, method 3620 can begin with an activity 3621 of displaying (e.g., “surfacing”) an authentication code (such as an SMS OTP) to the user. Activity 3621 can be similar or identical to activity 3611. The authentication code can be sent to the user in a text message, such as text message 610 (FIG. 6), text message 1410 (FIG. 14), and/or text message 2710 (FIG. 27). The user can be prompted to enter this authentication code, such in display screen 600 (FIG. 6), display screen 1400 (FIG. 14), and/or display screen 2700 (FIG. 27).

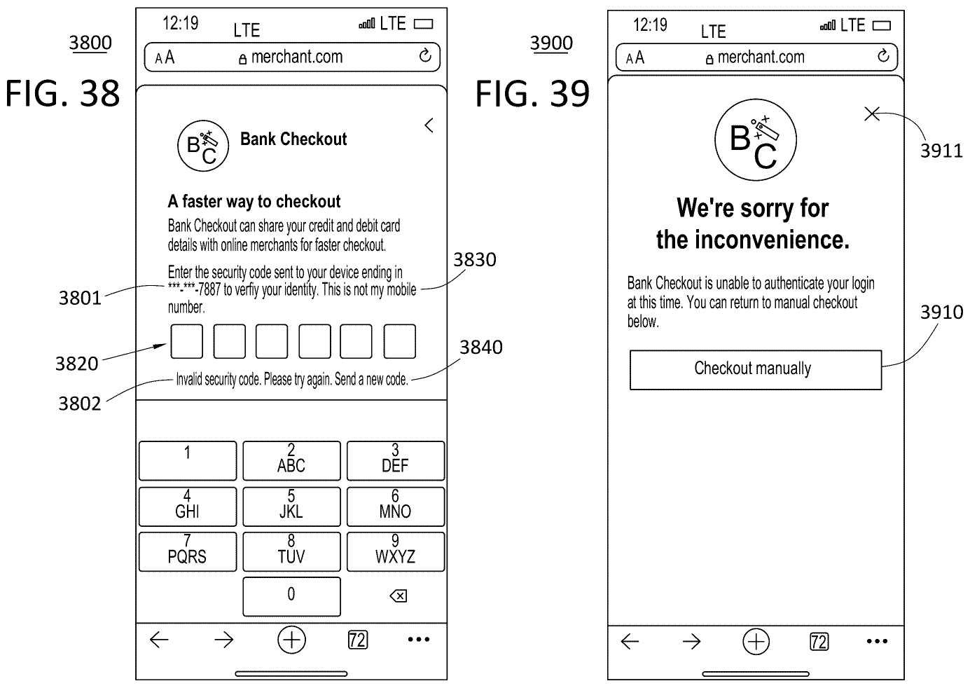

Next, method 3620 can include an activity 3622 of detecting that the user entered an authentication code that is incorrect (e.g., did not match the authentication code sent in the text message), or the authentication code is unable to be verified, or the user did not enter the authentication code with a predetermined period of time (e.g., 30 second, 60 second, 2 minutes, 5 minutes, 10 minutes, etc.). When this happens, display screen 3800 of FIG. 38 can be displayed to allow for one or more retries.

Display screen 3800 can be similar to display screen FIG. 6 (FIG. 6), and various elements of display screen 3800 can be similar or identical to various elements of display screen 600 (FIG. 6). Display screen 3800 can include a phone number display field 3801, an authentication failure message 3802, an authentication code field 3820, a change number selector 3830, and/or a new code send selector 3840. Phone number display field 3801 can be similar to phone number display field 601 (FIG. 6), authentication code field 3820 can be similar or identical to authentication code field 620 (FIG. 6), change number selector 3830 can be similar or identical to change number selector 630 (FIG. 6), and new code send selector 3840 can be similar or identical to new code send selector 640 (FIG. 6). Authentication failure message 3802 informs the user that the authentication code entered is invalid, and to please try again. The user can try to enter the authentication code again, such as to correct a typographical error in the first entry. New code send selector 3840 can be used to have a new code sent to the phone number, such as in another text message, upon when the user can enter the new phone number. When the authentication code is entered and the authentication code matches, the flow can continue similarly as described above, such as in connection with FIG. 8. If the authentication code does not match, activity 3623 of FIG. 36, described below, can be performed.

Returning to FIG. 36, method 3620 next can include an activity 3623 of detecting that the second attempt of the user at entering the authentication code was unsuccessful. For example, activity 3623 can detect that the user entered an authentication code that is incorrect (e.g., did not match the authentication code sent in the text message), or the authentication code is unable to be verified, or the user did not enter the authentication code with a predetermined period of time (e.g., 30 second, 60 second, 2 minutes, 5 minutes, 10 minutes, etc.). In some embodiments when this happens, display screen 3800 (FIG. 38) can be displayed again to allow for another retry. When the authentication code is entered and the authentication code matches, the flow can continue similarly as described above, such as in connection with FIG. 7. If the authentication code does not match, activity 3624 of FIG. 36, described below, can be performed. In other embodiments, only one retry is permitted, and when that retry is unsuccessful, display screen 3900 of FIG. 39, described below, can be displayed to lock the user out of the bank checkout process for a predetermined time period (e.g., 30 minutes, 1 hour, 2 hours, 6 hours, 12 hours, 1 day, 2 days, 1 week, etc.).

Continuing with FIG. 36, method 3620 next can include an activity 3624 of detecting that the third attempt of the user at entering the authentication code was unsuccessful. For example, activity 3624 can detect that the user entered an authentication code that is incorrect (e.g., did not match the authentication code sent in the text message), or the authentication code is unable to be verified, or the user did not enter the authentication code with a predetermined period of time (e.g., 30 second, 60 second, 2 minutes, 5 minutes, 10 minutes, etc.). When this happens, display screen 3900 of FIG. 39, described below, can be displayed, which indicates that the user is locked out of the bank checkout process for a predetermined time period (e.g., 30 minutes, 1 hour, 2 hours, 6 hours, 12 hours, 1 day, 2 days, 1 week, etc.).

Display screen 3900 can be similar to display screen FIG. 34 (FIG. 34), and various elements of display screen 3900 can be similar or identical to various elements of display screen 3400 (FIG. 34). Display screen 3900 can inform the user that the user cannot use the bank checkout process at this time, but can return later. In some embodiments, the lockout time period can be displayed. As shown in FIG. 39, display screen 3900 can include a manual checkout button 3910 and a close button 3911.

Returning to FIG. 36, method 3620 next can include an activity 3625 of detecting that the user has acknowledged the issue and returning to the merchant checkout page. If the user closes out of the display screen by selecting manual checkout button 3910 (FIG. 39) or selecting close button 3911 (FIG. 39), the user can be returned to the merchant checkout page, such as by displaying display screen 400 (FIG. 4). The bank checkout process can be suspended and not used for the remainder of that session. In many embodiments, an email can be sent to the email address, and/or a notification can be sent to the issuer, about the failed authentication.

In the same or other embodiments, other or additional authentication procedures can be used, such as multi-factor authentication with multiple authentication options. In some embodiments, the authentication options can include OTP, using background device authentication, using behavioral biometrics, using CVV verification, using knowledge-based verifications (e.g., enter last four digits of social security number), using shared secret verification (stored PIN (personal identification number)), and/or other authentication methods.

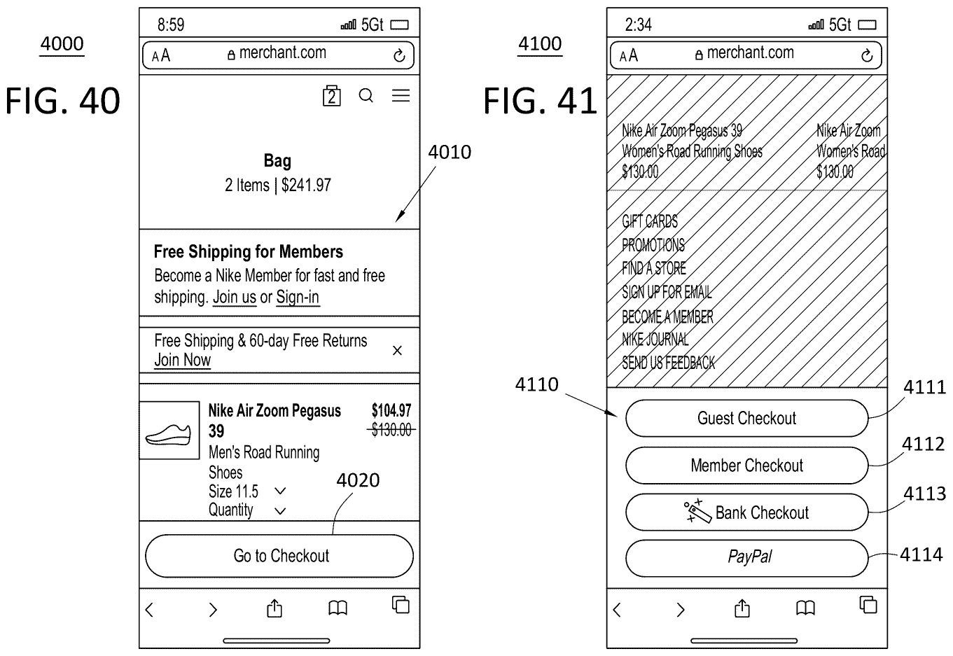

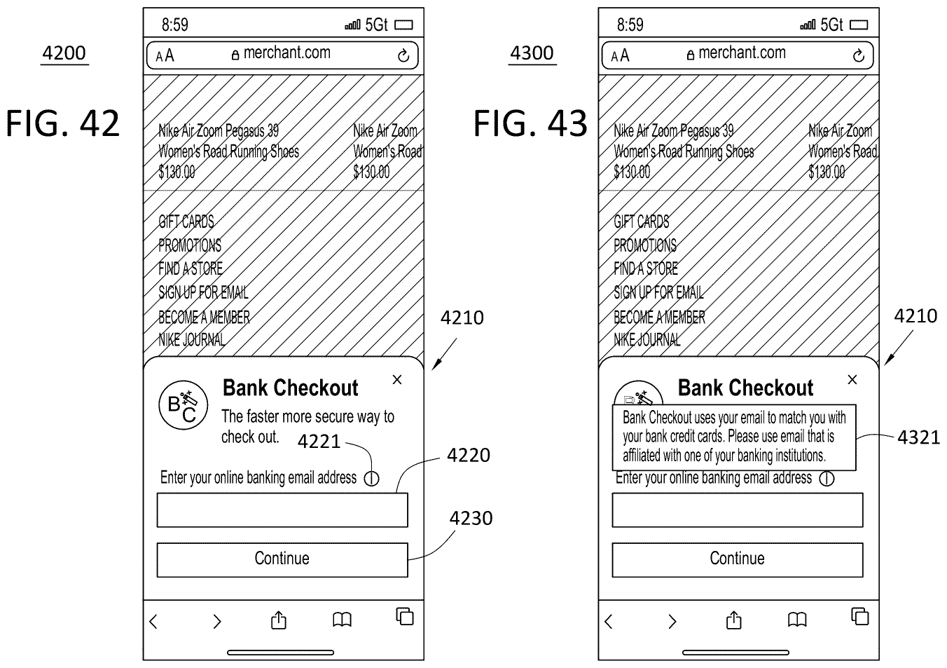

FIGS. 40-43 show a sequence of display screens 4000 (FIG. 40), 4100 (FIG. 41), 4200 (FIG. 42), and 4300 (FIG. 43) for initiating a bank checkout process in a merchant checkout process using a bank checkout button. As shown in FIG. 40, display screen 4000 can be a conventional online checkout screen of a merchant, which can include cart information 4010 and a checkout button 4020. When checkout button 4020 is selected, checkout options can be displayed, as shown in FIG. 41.

FIG. 41 shows a display screen 4100, which includes checkout options list 4110. Checkout options list 4110 can include checkout options, such as a checkout option 4111 for guest checkout (to allow a user to checkout without signing into a user account at the merchant), a checkout option 4112 for member checkout (to allow the user to checkout with signing into a user account at the merchant), a bank checkout option 4113 (which can provide the new functionality described herein), and another checkout option 4114, such as paying with PayPal. Bank checkout option 4113 can provide another way to initiate the bank checkout process. When the user selects bank checkout option 4113, display screen 4200 of FIG. 42 can be displayed, which can allow the user to enter the email address for the user to see if there is a wallet for the user in the wallet directory.

As shown in FIG. 42, display screen 4200 can include an input form 4210, which can include an email field 4220, an information selector 4221, and a continue button 4230. User can input the email address of the user in email field 4220, which, after the user selects continue button 4230, can be used similarly as the email entered in email field 410 (FIG. 4), to determine if the email address is associated with a wallet. If the user selects information selector 4221, additional information about the bank checkout process can be displayed to the user, such as shown in an informational tool-tip 4321 displayed over input form 4210 in display screen 4300 of FIG. 43. Once merchant system 320 (FIG. 3) and/or wallet system 310 (FIG. 3) determines that the bank checkout process is available to the user based on the email address entered being associated with an existing wallet in the wallet directory, the bank checkout process can proceed, such as displaying a display screen similar to display screen 500 (FIG. 5) and/or display screen 600 (FIG. 6).

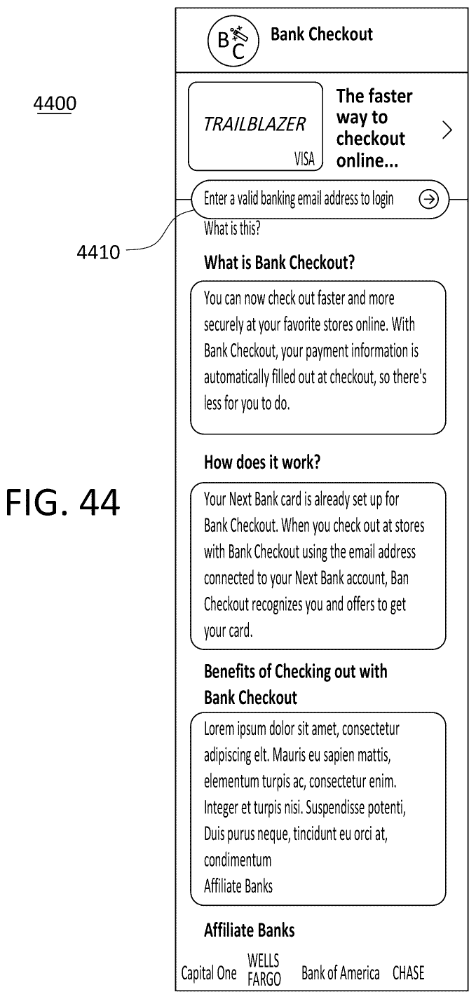

FIGS. 44-50 show various display screens of a wallet management interface, such as a website that can be used by a user to manage the wallet created for the user. As shown in FIG. 44, display screen 4400 shows an introductory webpage of a website provided to users (e.g., 350 (FIG. 3)) to allow the users to manage wallets associated with the users. The website can be provided by an entity that provides or is associated with wallet system 310 (FIG. 3)). Display screen 4400 can show information about the bank checkout and how it works. In some cases, the user can enter the wallet management interface (e.g., the website) directly through a webpage, or through a link provided by the merchant in the merchant checkout process and/or the bank checkout process. In many embodiments, display screen 4400 can include an email field 4410. Email field 4410 can be similar to email field 410 (FIG. 4) and/or email field 4220 (FIG. 42). When a user inputs an email address in email field 4410, merchant system 320 (FIG. 3) and/or wallet system 310 (FIG. 3) can determine if there is a wallet associated with the email address entered in email field 4410. If a wallet is found, an authentication code can be sent to the phone number associated with the wallet.

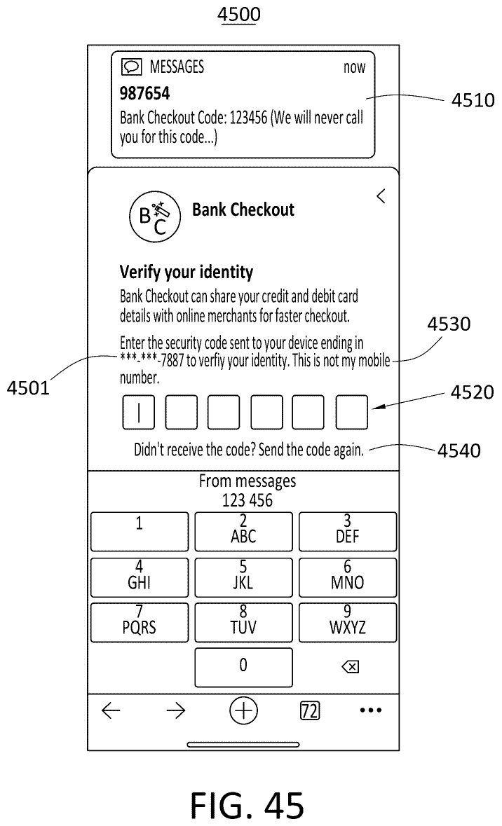

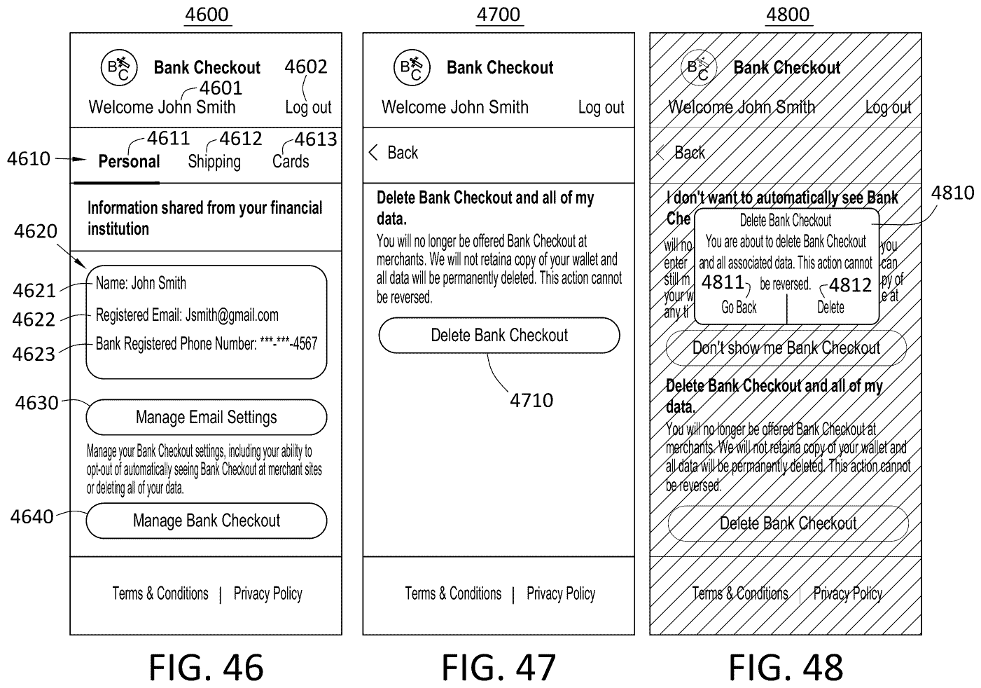

Display screen 4500 of FIG. 45 shows an example of a display screen that can be to allow the user to enter the authentication code. Display screen 4500 can be similar to display screen FIG. 6 (FIG. 6), and various elements of display screen 4500 can be similar or identical to various elements of display screen 600 (FIG. 6). A text message 4510 can be sent to the mobile phone of the user (outside of the merchant checkout process and/or the bank checkout process), and text message 4510 can include the authentication code. Text message 4510 can be similar to text message 610 (FIG. 6). Display screen 4500 can include a phone number display field 4501, an authentication code field 4520, a change number selector 4530, and/or a new code send selector 4540. Phone number display field 4501 can be similar to phone number display field 601 (FIG. 6), authentication code field 4520 can be similar or identical to authentication code field 620 (FIG. 6), change number selector 4530 can be similar or identical to change number selector 630 (FIG. 6), and new code send selector 4540 can be similar or identical to new code send selector 640 (FIG. 6). When the authentication code is entered and the authentication code matches, the flow can proceed to a wallet management interface portal for the user, such as displayed in display screen 4600 of FIG. 46.

As shown in FIG. 46, display screen 4600 can include a name field 4601, a logout selector 4602, and/or a tab row 4610. Name field 4601 can display a name of the user. Logout selector 4602 can be selected by the user to log out of the wallet management interface. Tab row 4610 can include a personal tab 4611, a shipping tab 4612, and a card tab 4613. Personal tab 4611 is selected in display screen 4600, such that personal information about the user is displayed and able to be edited. For example, personal tab 4611 can include user information 4620, a manage email button 4630, and/or a manage bank checkout button 4640. User information 4620 can include a name field 4621, an email field 4622, and a phone number field 4623. Name field 4621 can show the name registered in the wallet associated with the user in the wallet directory. Email field 4622 can show the email address registered in the wallet associated with the user in the wallet directory. Phone number field 4623 can show the phone number registered in the wallet associated with the user in the wallet directory. Manage email button 4630 can be selected by the user to update an email address associated with the wallet for the user. Manage bank checkout button 4640 can be selected by the user to manage other options, such as opting out of using bank checkout and deleting the wallet associated with the user, in which case display screen 4700 of FIG. 47 can be displayed.

As shown in FIG. 47, display screen 4700 can provide information to the user about deleting the wallet and opting out of using the bank checkout process. Display screen 4700 can include a delete button 4710. When the user selects delete button 4710, a confirmation box 4810 can be displayed over the display screen 4700, such as shown in display screen 4800 of FIG. 48. As shown in FIG. 48, confirmation box 4810 can include a go back selector 4811 to allow the user to not proceed with deletion (and return to display screen 4600 (FIG. 46)), and a delete selector 4812 to allow the user to proceed with the deletion.

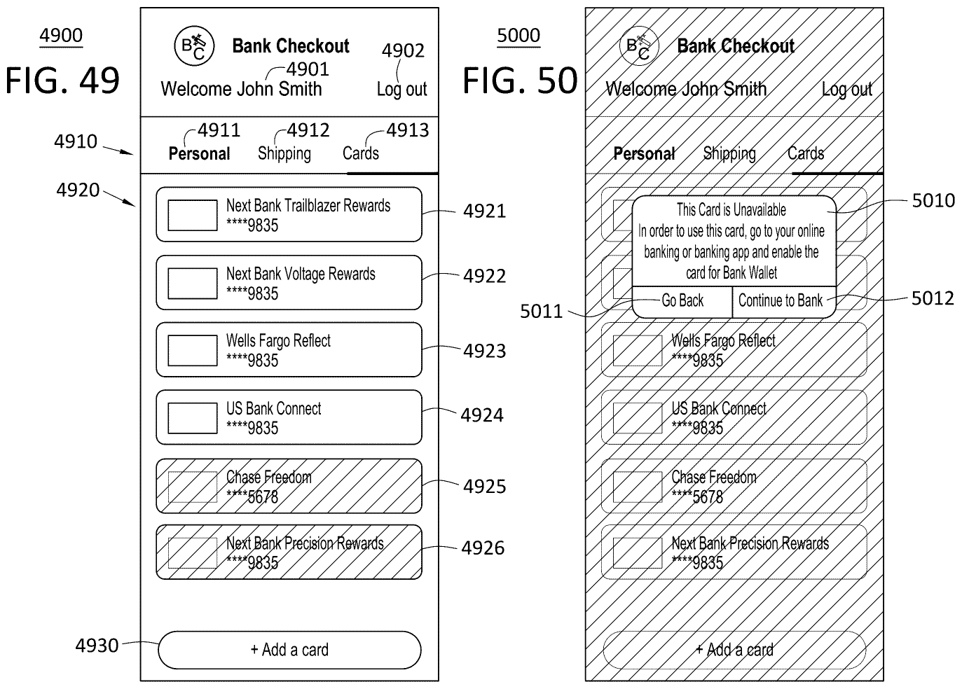

Returning to FIG. 46, shipping tab 4612 can display shipping addresses stored in the wallet, and allow the user to add, update, and/or remove shipping addresses associated with the wallet for the user. Card tab 4613 can allow the user to add, update, and/or remove cards associated with the wallet for the user. When card tab 4613 is selected, display screen 4900 of FIG. 49 can be displayed.

As shown in FIG. 49, display screen 4900 can include a name field 4901, a logout selector 4902, and/or a tab row 4910. Name field 4901 can be similar or identical to name field 4601 (FIG. 46), logout selector 4902 can be similar or identical to logout selector 4602 (FIG. 46), and tab row 4910 can be similar or identical to tab row 4610 (FIG. 46). Tab row 4910 can include a personal tab 4911, a shipping tab 4912, and a card tab 4913. Personal tab 4911 can be similar or identical to personal tab 4611 (FIG. 46), shipping tab 4912 can be similar or identical to shipping tab 4612, and card tab 4913 can be similar or identical to card tab 4613 (FIG. 46). Display screen 4900 shows when card tab 4913 is selected, in which card tab 4913 includes a card list 4920 and an add card button 4930. Card list 4920 can include cards registered with the wallet for the user, such as cards 4921-4926. Cards 4925-4926 are shown greyed out, indicating that those cards are locked. If the user clicks on one of these locked cards, an informational box 5010 can be displayed over display screen 4900, as shown in display screen 5000 of FIG. 50. As shown in FIG. 50, informational box 5010 can include a go back selector 5011 to allow the user to return to return to display screen 4900 (FIG. 49), and a go to bank selector 5012 to allow the user to go to a website and/or application provided by the issuer associated with the locked card that was selected by the user in display screen 4900 (FIG. 49). In some embodiments, bank selector 5012 can deep-link the user to the banking app provided by the issuer. In many embodiments, a user can lock and/or unlock a card in the banking app provided by the issuer, but not in the wallet management interface. In some embodiments, if the wallet management is accessed by the user from an issuer, such as from a website of an issuer, the cards associated with that issuer can be listed at the top of the card list (e.g., 4920) and/or the card list can be sorted or filtered based on the issuer.

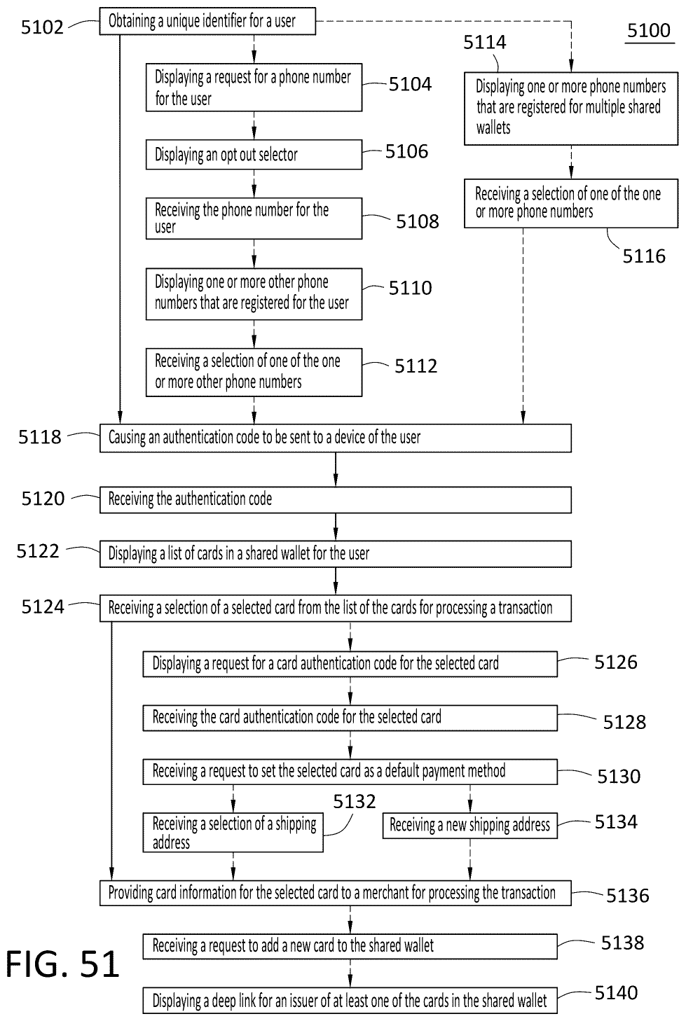

Turning ahead in the drawings, FIG. 51 illustrates a flow chart for a method 5100 of providing a user interface for online checkout using a shared wallet across issuers, according to an embodiment. Method 5100 is merely exemplary and is not limited to the embodiments presented herein. Method 5100 can be employed in many different embodiments or examples not specifically depicted or described herein. In some embodiments, the procedures, the processes, and/or the activities of method 5100 can be performed in the order presented. In other embodiments, the procedures, the processes, and/or the activities of method 5100 can be performed in any suitable order. In still other embodiments, one or more of the procedures, the processes, and/or the activities of method 5100 can be combined or skipped.

In many embodiments, system 300 (FIG. 3), wallet system 310 (FIG. 3), and/or merchant system 320 (FIG. 3) can be suitable to perform method 5100 and/or one or more of the activities of method 5100. In these or other embodiments, one or more of the activities of method 5100 can be implemented as one or more computing instructions configured to run at one or more processors and configured to be stored at one or more non-transitory computer readable media. Such non-transitory computer readable media can be part of system 300 (FIG. 3), wallet system 310 (FIG. 3), and/or merchant system 320 (FIG. 3). The processor(s) can be similar or identical to the processor(s) described above with respect to computer system 100 (FIG. 1). In some embodiments, method 5100 and other activities in method 5100 can include using a distributed network including distributed memory architecture to perform the associated activity. This distributed architecture can reduce the impact on the network and system resources to reduce congestion in bottlenecks while still allowing data to be accessible from a central location.

Referring to FIG. 51, method 5100 can include an activity 5102 of obtaining a unique identifier for a user. The user can be similar or identical to user 350 (FIG. 3). In some embodiments, the unique identifier can be an email address for the user, such as an email address that is registered for the user with one or more of multiple different issuers of cards in a shared wallet for the user. In some embodiments, the unique identifier can be provided by the user to the merchant through a second user interface displayed to the user. The second user interface can be similar or identical to the user interface for the merchant checkout process described above, such as the user interface that provides display screens 400 (FIG. 4), 1200 (FIG. 12), 1300 (FIG. 13), 1900 (FIG. 19), 2500 (FIG. 25), 4000 (FIG. 40), and 4100 (FIG. 41). In some embodiments, the unique identifier can be provided by the user to the merchant through the second user interface after the user starts a checkout process at the merchant. For example, the unique identifier (e.g., an email address of the user) can be provided by the user to the merchant in email field 410 (FIG. 4). In some embodiments, activity 5102 of obtaining the unique identifier can include receiving the unique identifier from the merchant based on the unique identifier being provided to the merchant by the user.

In several embodiments, method 5100 optionally can include an activity 5104 of displaying, through a first user interface, a request for a phone number for the user. In some embodiments, the first user interface can be launched by the merchant after the merchant displays the second user interface to the user. In some embodiments, the first user interface can be launched by the merchant through a software development kit (SDK), as described above. The first user interface can be similar or identical to the user interface for the bank checkout process described above, such as the user interface that provides display screens 500 (FIG. 5), display screens 600 (FIG. 6), 700 (FIG. 7), 800 (FIG. 8), 900 (FIG. 9), 1000 (FIG. 10), 1100 (FIG. 11), 1400 (FIG. 14), 1500 (FIG. 15), 1600 (FIG. 16), 1700 (FIG. 17), 1800 (FIG. 18), 2000 (FIG. 20), 2100 (FIG. 21), 2200 (FIG. 22), 2300 (FIG. 23), 2400 (FIG. 24), 2600 (FIG. 26), 2700 (FIG. 27), 2800 (FIG. 28), 2900 (FIG. 29), 3000 (FIG. 30), 3100 (FIG. 31), 3200 (FIG. 32), 3300 (FIG. 33), 3400 (FIG. 34), 3500 (FIG. 35), 3700 (FIG. 37), 3800 (FIG. 38), 3900 (FIG. 39), 4200 (FIG. 42), and 4300 (FIG. 43). In some embodiments, the first user interface can be displayed on the device of the user. For example, the request for the phone number can be displayed as shown in display screen 500 (FIG. 5), which prompts for the phone number, to be input by the user in phone number field 540 (FIG. 5).

In a number of embodiments, method 5100 optionally can include an activity 5106 of displaying, through the first user interface, an opt out selector to allow the user to request deactivating the shared wallet for the user. In many embodiments, the opt out selector can be displayed along with the request for the phone number displayed in activity 5104. For example, the opt out selector can be displayed as shown in display screen 500 (FIG. 5), which displays opt-out selector 510 (FIG. 5), which can allow the user to initiate an opt-out process, as shown in FIGS. 26-31 and described above.

In several embodiments, method 5100 optionally can include an activity 5108 of receiving, through the first user interface, the phone number for the user. For example, the phone number can be received as shown in display screen 500 (FIG. 5), which can receive the phone number from the user in phone number field 540 (FIG. 5).

In a number of embodiments, method 5100 optionally can include an activity 5110 of, when the phone number for the user is not registered for the user with one or more of the multiple different issuers, displaying, through the first user interface for selection by the user, one or more other phone numbers that are registered for the user with the multiple different issuers. For example, the other phone numbers can be similar or identical to phone number options 3211-3214 (FIG. 32) of phone number list 3210 (FIG. 32), as shown in display screen 3200 (FIG. 32).

In several embodiments, method 5100 optionally can include an activity 5112 of receiving, through the first user interface, a selection by the user of one of the one or more other phone numbers. For example, the selection can be made by the user of one of phone number options 3211-3214 (FIG. 32) of phone number list 3210 (FIG. 32), as shown in display screen 3200 (FIG. 32).

In a number of embodiments, method 5100 optionally can include an activity 5114 of, when the unique identifier is associated with multiple shared wallets, displaying, through the first user interface for selection by the user, one or more phone numbers that are registered for the multiple shared wallets. For example, the other phone numbers can be similar or identical to phone number options 3511-3512 (FIG. 35) of phone number list 3510 (FIG. 35), as shown in display screen 3500 (FIG. 35).

In several embodiments, method 5100 optionally can include an activity 5116 of receiving, through the first user interface, a selection by the user of one of the one or more phone numbers. For example, the selection can be made by the user of one of phone number options 3511-3512 (FIG. 35) of phone number list 3510 (FIG. 35), as shown in display screen 3500 (FIG. 35).

In a number of embodiments, method 5100 additionally can include an activity 5118 of causing an authentication code to be sent to a device of the user. In some embodiments, the authentication code can be sent to the device of the user using the phone number based on the phone number of the user being registered for the user with one or more of the multiple different issuers. In various embodiments, the authentication code can be sent to the device of the user using the selection of the phone number, such as the phone number selected in activities 5112 and/or 5116. For example, the authentication code can be similar or identical to the OTP included in text message 610 (FIG. 6), text message 1410 (FIG. 14), and/or text message 2710 (FIG. 27).

In some embodiments, the authentication code sent to the device of the user is performed as part of a retry attempt after one or more failed authentication attempts. For example, the one or more failed authentication attempts can include a one-time passcode mismatch, a timeout, or another type of failure, such as described above in connection with FIG. 36.

In several embodiments, method 5100 further can include an activity 5120 of receiving, through a first user interface displayed to the user, the authentication code. For example, the authentication code can be received as shown in authentication code field 620 (FIG. 6), authentication code field 1420 (FIG. 14), and/or authentication code field 2720 (FIG. 27). In several embodiments, the authentication code can be verified before performing activity 5122 described below.

In a number of embodiments, method 5100 additionally can include an activity 5122 of displaying, to the user through the first user interface, a list of cards in a shared wallet for the user. In some embodiments, the cards can be issued by multiple different issuers. In some embodiments, the shared wallet can be accessible to multiple different merchants. For example, the list of cards can be similar or identical to card list 810 (FIG. 8) and/or card list 1710 (FIG. 17).

In some embodiments, the list of the cards is displayed to the user due to the user not having previously selected a card in shared wallet for a transaction, such as the first time the user uses the shared wallet, as shown in the process of FIGS. 4-13, and specifically card list 810 in display screen 800 (FIG. 8). In the same or other embodiments, the list of the cards can be displayed to the user after receiving, through the first user interface, a request from the user to select a card for the transaction. For example, the request can be similar or identical to the user selecting card selector 1611 (FIG. 16). In some embodiments, the list of the cards displayed on the first user interface further can include a respective card image associated with each of the cards. For example, the card image can be similar or identical to card image 815 (FIG. 8).

In several embodiments, method 5100 further can include an activity 5124 of receiving, through the first user interface displayed to the user, a selection by the user of a selected card from the list of the cards for processing a transaction. For example, the user can select a card from card list 810 (FIG. 8) and/or card list 1710 (FIG. 17).

In a number of embodiments, method 5100 optionally can include an activity 5126 of, after receiving the selection by the user of the selected card, displaying, to the user through the first user interface, a request for a card authentication code for the selected card. In some embodiments, the card authentication code can be the CVV for the card. For example, the request for the card authentication code can be similar or identical to the request to enter the CVV in CVV field 912 (FIG. 9), as displayed in display screen 900 (FIG. 9).

In several embodiments, method 5100 optionally can include an activity 5128 of receiving, through the first user interface, the card authentication code for the selected card. For example, the user can enter the card authentication code such as entering the CVV in CVV field 912 (FIG. 9). In many embodiments, the card authentication code can be verified for the selected card before performing activity 5136 described below.

In a number of embodiments, method 5100 optionally can include an activity 5130 of receiving, through the first user interface, a request to set the selected card as a default payment method for the shared wallet. For example, the request to set the selected card as the default payment method can be received through default payment selector 911 (FIG. 9) and/or default payment selector 1721 (FIG. 17).

In several embodiments, method 5100 optionally can include an activity 5132 of receiving, through the first user interface, a selection of a shipping address for the transaction from among shipping addresses stored in the shared wallet. For example, the selection of the shipping address can be received through a selection of one of shipping options 1021-1022 (FIG. 10) in display screen 1000 (FIG. 10), a selection of one of shipping options 1821-1823 (FIG. 18) in display screen 1800 (FIG. 18), and/or a selection of one of shipping options 1822, 1823, and 2024 (FIG. 20) display screen 2000 (FIG. 20).

In a number of embodiments, method 5100 optionally can include an activity 5134 of receiving, through the first user interface, a new shipping address for the transaction. For example, the new shipping address can be received through display screens 2100 (FIG. 21), 2200 (FIG. 22), and 2300 (FIG. 23). In many embodiments, the new shipping address can be stored in the shared wallet.

In several embodiments, method 5100 further can include an activity 5136 of providing card information for the selected card to a merchant for processing the transaction. In many embodiments, the card information for the selected card can include a token cryptogram for processing the transaction, which, in some embodiments, can facilitate the merchant completing the transaction without receiving the full card details (e.g., full card number, etc.). In various embodiments, the merchant can display one or more checkout pages to the user through the second user interface. In some embodiments, the one or more checkout pages can include an indication of the selected card and a selector to allow the user to request processing of the transaction. In some embodiments, the one or more checkout pages further can include an indication of a shipping address to be used for the transaction. For example, the one or more checkout pages can be similar or identical to display screen 1200 (FIG. 12), which includes card information 1250 (FIG. 12) showing the card to be used for the transaction, shipping information 1220 (FIG. 12) showing the shipping address to be used for the transaction, and order button 1270 (FIG. 12) to allow the user to request processing of the transaction; display screen 1900 (FIG. 19), and/or display screen 2500 (FIG. 25).

In a number of embodiments, method 5100 optionally can include an activity 5138 of receiving a request from the user to add a new card to the shared wallet. For example, the request to add a new card can be received through add card button 4930 (FIG. 49) as shown on the wallet management interface, as described above.

In several embodiments, method 5100 optionally can include an activity 5140 of displaying to the user a deep link for an issuer of at least one of the cards in the shared wallet. For example, the deep link for the issuer can be similar or identical to bank selector 5012 (FIG. 50) displayed on the wallet management interface, as described above.

Although systems and methods for providing a user interface for online checkout using a shared wallet across issuers has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that any element of FIGS. 3-51 may be modified, and that the foregoing discussion of certain of these embodiments does not necessarily represent a complete description of all possible embodiments. For example, one or more of the procedures, processes, or activities of FIG. 51 may include different procedures, processes, and/or activities and be performed by many different modules, in many different orders. As another example, the components within system 300 (FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A computer-implemented method comprising:
obtaining a unique identifier for a user;
causing an authentication code to be sent to a device of the user;
receiving, through a first user interface displayed to the user, the authentication code;
displaying, to the user through the first user interface, a list of cards in a shared wallet for the user, wherein the cards are issued from multiple different issuers, and the shared wallet is accessible to multiple different merchants;
receiving, through the first user interface displayed to the user, a selection from the user of a selected card from the list of the cards for processing a transaction; and
providing card information for the selected card to a merchant for processing the transaction.

2. The computer-implemented method of claim 1, wherein:
the unique identifier is provided from the user to the merchant through a second user interface displayed to the user; and
the first user interface is launched by the merchant after the merchant displays the second user interface to the user.

3. The computer-implemented method of claim 2, wherein:
the merchant displays one or more checkout pages to the user through the second user interface, wherein the one or more checkout pages comprise an indication of the selected card and a selector to allow the user to request processing of the transaction; and
the one or more checkout pages further comprise an indication of a shipping address to be used for the transaction.

4. The computer-implemented method of claim 2, wherein the first user interface is launched by the merchant through a software development kit (SDK).

5. The computer-implemented method of claim 2, wherein the unique identifier is provided from the user to the merchant through the second user interface after the user starts a checkout process at the merchant.

6. The computer-implemented method of claim 1, wherein obtaining the unique identifier comprises:
receiving the unique identifier from the merchant based on the unique identifier being provided to the merchant from the user.

7. The computer-implemented method of claim 1, wherein the unique identifier comprises an email address that is registered for the user with one or more of the multiple different issuers.

8. The computer-implemented method of claim 1 further comprising:
displaying, through the first user interface, a request for a phone number for the user; and
receiving, through the first user interface, the phone number for the user.

9. The computer-implemented method of claim 8, wherein the authentication code is sent to the device of the user using the phone number based on the phone number of the user being registered for the user with one or more of the multiple different issuers.

10. The computer-implemented method of claim 8 further comprising:
when the phone number for the user is not registered for the user with one or more of the multiple different issuers, displaying, through the first user interface for selection by the user, one or more other phone numbers that are registered for the user with the multiple different issuers; and
receiving, through the first user interface, a selection from the user of one of the one or more other phone numbers,
wherein:
the authentication code is sent to the device of the user using the one of the one or more other phone numbers.

11. The computer-implemented method of claim 1 further comprising:
displaying, through the first user interface, an opt out selector to allow the user to request deactivating the shared wallet for the user.

12. The computer-implemented method of claim 1 further comprising:
when the unique identifier is associated with multiple shared wallets, displaying, through the first user interface for selection by the user, one or more phone numbers that are registered for the multiple shared wallets; and
receiving, through the first user interface, a selection from the user of one of the one or more phone numbers,
wherein:
the authentication code is sent to the device of the user using the one of the one or more phone numbers.

13. The computer-implemented method of claim 1, wherein the authentication code is verified before the list of the cards is displayed to the user.

14. The computer-implemented method of claim 1, wherein the list of the cards displayed on the first user interface further comprises a respective card image associated with each of the cards.

15. The computer-implemented method of claim 1 further comprising:
after receiving the selection from the user of the selected card, displaying, to the user through the first user interface, a request for a card authentication code for the selected card; and
receiving, through the first user interface, the card authentication code for the selected card,
wherein:
the card authentication code is verified for the selected card before providing the card information for the selected card to the merchant for processing the transaction.

16. The computer-implemented method of claim 1, wherein the card information for the selected card comprises a token cryptogram for processing the transaction.

17. The computer-implemented method of claim 1 further comprising:
receiving a request from the user to add a new card to the shared wallet.

18. The computer-implemented method of claim 1 further comprising:
displaying to the user a deep link for an issuer of at least one of the cards in the shared wallet.

19. A system comprising one or more processors and one or more non-transitory computer-readable media storing computing instructions that, when executed on the one or more processors, cause the one or more processors to perform operations comprising:
obtaining a unique identifier for a user;
causing an authentication code to be sent to a device of the user;
receiving, through a first user interface displayed to the user, the authentication code;
displaying, to the user through the first user interface, a list of cards in a shared wallet for the user, wherein the cards are issued from multiple different issuers, and the shared wallet is accessible to multiple different merchants;
receiving, through the first user interface displayed to the user, a selection from the user of a selected card from the list of the cards for processing a transaction; and
providing card information for the selected card to a merchant for processing the transaction.

20. One or more non-transitory computer-readable media storing computing instructions that, when executed on one or more processors, cause the one or more processors to perform operations comprising:
obtaining a unique identifier for a user;
causing an authentication code to be sent to a device of the user;
receiving, through a first user interface displayed to the user, the authentication code;
displaying, to the user through the first user interface, a list of cards in a shared wallet for the user, wherein the cards are issued from multiple different issuers, and the shared wallet is accessible to multiple different merchants;
receiving, through the first user interface displayed to the user, a selection from the user of a selected card from the list of the cards for processing a transaction; and
providing card information for the selected card to a merchant for processing the transaction.
